(19) United States
(12) Patent Application Publication
(10) Pub. No.: US 2020/0171534 A1
(43) Pub. Date: Jun. 4, 2020

(54) IN-SITE THIN COATING OF SILICA PARTICLES ONTO PLASTIC FILMS AND THEIR APPLICATIONS

(71) Applicant: BAR-ILAN UNIVERSITY, Ramat Gan (IL)

(72) Inventors: Shlomo MARGEL, Rehovot (IL); Sharon BRETLER, Halamish (IL); Sarit COHEN, Peduel (IL); Naftali KANOVSKY, Rehovot (IL)

(21) Appl. No.: 16/618,128

(22) PCT Filed: Mar. 21, 2019
(86) PCT No.: PCT/IL2019/050323

§ 371 Date: Nov. 28, 2019

Related U.S. Application Data
(60) Provisional application No. 62/645,839, filed on Mar. 21, 2018.

(51) Int. Cl. B05D 1/06; B05D 1/36; B05D 3/10

(52) U.S. Cl. CPC B05D 1/06; B05D 1/36; B05D 3/108; B05D 1/18; B05D 2601/24; B05D 2601/22; B05D 2602/00; B05D 2201/02

(57) ABSTRACT

A composition comprising nano- or micro-particles grafted onto a surface are disclosed. Process of preparing the compositions and methods of using the same, such as for anti-fogging, anti-fouling and anti-scratching are provided.

### CROSS REFERENCE TO RELATED APPLICATIONS

This application claims the benefit of priority from U.S. Provisional Patent Application No. 62/645,839 filed Mar. 21, 2018, entitled “IN-SITE THIN COATING OF SILICA PARTICLES ONTO PLASTIC FILMS AND THEIR APPLICATIONS”, the contents of which are incorporated herein by reference in their entirety.

### FIELD OF THE INVENTION

The present invention relates to inorganic and inorganic-organic hybrid particles-in situ coated sheets, compositions comprising the same, processes of preparing such compositions and uses thereof.

### BACKGROUND OF THE INVENTION

Self-cleaning surfaces are a class of materials with the inherent ability to remove any debris or bacteria from their surfaces in a variety of ways. The self-cleaning functionality of these surfaces are commonly inspired by natural phenomena observed in lotus leaves, gecko feet, and water striders to name a few. The majority of self-cleaning surfaces can be placed into three categories: 1) Superhydrophobic, 2) Superhydrophilic, and 3) Photocatalytic such as TiO₂. Hydrophilic coatings based on titania (titanium dioxide), however, have an additional property: they can chemically break down absorbed dirt in sunlight. A similar family to titania may be halamine compounds which release oxidative halogen such as chlorine or bromine and thereby kill or decompose microbials and organic contaminants, respectively. N halamines are a class of compounds, containing one or more nitrogen-halogen covalent bonds, and are known for their antimicrobial activity. N-halamines are similar to bleach (NaOCl), but possess several advantages including long-term stability in aqueous solutions, specificity, low toxicity, relatively inexpensive, and the capacity for efficient regeneration to carry halogens. The latter is a unique property that distinguishes N-halamines from other antimicrobials.

Many eyeglass lenses made of plastic materials, such as polycarbonate, are easily scratched and should be protected with a permanent scratch resistant coating. A scratch resistant layer is essential to protect the surface of plastic sheets as well as optical devices from damage.

Fogging, which occurs due to the condensation of water vapor into small droplets dispersed on a surface, most commonly occurs when the temperature of the surface falls below the dew-point temperature and the air temperature. Fogging reduces the efficiency of many devices and constitutes nuisances in applications such as agricultural films, and windows—both in buildings and in cars.

Anti-fogging (AF) agents are used to coat plastic films forming a continuous and uniform transparent layer of water preventing fog formation. Coatings that reduce the tendency for surfaces to “fog up” have been reported. These so-called anti-fogging coatings improve the wettability of a surface by allowing a thin layer of water film to form on the surface instead of discrete droplets. AF additives are mainly non-ionic surfactants that include two parts: a hydrophilic head and a lipophilic tail. The typical additives commonly used are glycerol esters, sorbitan esters, and alcohol ethoxylates. The AF additives form a hydrophilic smooth surface, which easily reacts with the water molecules allowing the condensed water droplets to spread into a continuous and uniform transparent layer on the fabricated film, thus preventing fog.

The degree of hydrophilicity of surfaces, measured by water droplet contact angle, provides a measure for their anti-fogging ability. Generally, surfaces with a water contact angle degree of less than 40° may often explored as anti-fog surfaces. The main reason is that condensing water droplets on this type of surface can rapidly spread into a uniform and non-light-scattering water film. In this case, although condensation still occurs, the surface remains optically clear, without disruption of light transfer. Hydrophilic polymeric systems containing hydroxyl groups (OH), amino groups (NH₂) and carboxylic groups (COOH) are often utilized as anti-fog formulas. Another important property of anti-fog films is the roughness of the film surface. Fog will accumulate on rough surfaces, as the water droplets penetrate the holes in the surface and stay there. The combination of both a smooth surface, appropriate chemistry, a low water contact angle and non-migrative yields a good anti-fog film. However, the preparation of optical quality durable thin-film coatings with good coating characteristics and mechanical durability is still a great challenge.

Superhydrophobic surfaces have received rapidly increasing research interest because of their tremendous application potential in areas such as self-cleaning and anti-icing surfaces, drag reduction, and enhanced heat transfer. A surface is considered superhydrophobic if a water droplet beads up (with contact angles >150°), and moreover, if the droplet can slide away from the surface readily (i.e., it has small contact angle hysteresis). This behavior, known as the lotus or self-cleaning effect, is found to be a result of the hierarchical rough structure, as well as the wax layer present on the leaf surface.

Superhydrophobic surfaces exhibit a low surface energy and are not wetted by water. This means that water forms a droplet that may easily roll off if the surface is tilted; while rolling off, the droplet may also remove dirt from the surface, known as a self-cleaning or lotus leaf effect. It is well-known that the superhydrophobic property is the result of a combination of desired surface roughness and low surface energy of certain materials.

### SUMMARY OF THE INVENTION

According to one aspect, the present invention provides a process for coating a substrate with plurality of oxide particles, comprising the steps of (i) providing a substrate selected from an hydrophilic substrate, or an at least partially oxidized substrate; and (ii) contacting one or more oxide monomers with the substrate, under conditions suitable for the one or more oxide monomers to polymerize into oxide particles bound to the substrate, thereby forming a first layer of a plurality of oxide particles coating a substrate.

In some embodiments, the process further comprises a step (iii) of washing the substrate to remove non-bound oxide particles.

In some embodiments, the process further comprises a step (iv) contacting one or more oxide monomers with the substrate under conditions suitable for the one or more oxide monomers to polymerize into oxide particles bound to the first layer, thereby forming a second layer.

In some embodiments, contacting is via dipping, spraying, spreading, curing, or printing.

In some embodiments, one or more oxide monomers have a general formula of M(OR)₄, M(R′)ₙ(OR)₄₋ₙ, or a combination thereof, wherein M is a metal selected from Si, Ti, Zn, or Fe, and R and R′ are each independently selected from hydrogen, methyl, alkyl, alkenyl, alkynyl, cycloalkyl, heteroalicyclic, aryl, heteroaryl, hydroxy, alkoxy, aryloxy, thiohydroxy, thioalkoxy, thioaryloxy, halide, amine, amide, carbonyl, thiocarbonyl, carboxy, thiocarboxy, epoxide, sulfonate, sulfonyl, sulfinyl, sulfonamide, nitro, nitrile, melamine, isonitrile, thiirane, aziridine, nitroso, hydrazine, sulfate, azide, phosphonyl, phosphinyl, urea, thiourea, carbamyl and thiocarbamyl.

In some embodiments, the substrate comprises a polymeric substrate, or a glass substrate.

In some embodiments, the glass substrate is selected from a borosilicate-based glass substrate, silicon-based glass substrate, ceramic-based glass substrate, silica/quartz-based glass substrate, aluminosilicate-based glass substrate, or any combination thereof.

In some embodiments, the polymeric substrate comprises a polymer selected from the group consisting of: polypropylene (PP), polycarbonate (PC), high-density polyethylene (HDPE), low-density polyethylene (LDPE), very low-density polyethylene (VLDPE), polyester, polyethylene terephthalate (PET), polycarbonate (PC), polyvinyl chloride (PVC), polymethyl methacrylate (PMMA), silicon, polyacetal, silicone rubber, cellulose, cellulose derivatives, poly(2-hydroxyethyl methacrylate) (pHEMA), nylon, and any combination thereof.

In some embodiments, the oxide monomers are in a solution comprising a protic solvent, selected from the group consisting of: water, ethanol, methyl ethyl ketone, isopropanol, methanol, butanol and a combination thereof.

In some embodiments, the solution is devoid of a curing agent, a film former, a surfactant, or a stabilizer.

In some embodiments, the solution further comprises a silane coupling agent.

In some embodiments, the silane coupling agent is selected from the group consisting of: 3 -(Methacryloyloxy)propyl]trimethoxy silane (MPS), 3-(aminooxy)propyl]trimethoxysilane (APS), uridopropyltrimethoxysilane, trialkylpropypylmelaminesilane, triethoxysilylpropyl hydantoin and any combination thereof.

In some embodiments, the ratio of the oxide precursor and the coupling agent ranges from 95:5 to 5:95, respectively.

In some embodiments, there is provided a process for receiving a composition characterized by a water contact angle of at least 130°.

In some embodiments, there is provided a process for receiving a scratch resistant composition.

In some embodiments, there is provided a process for receiving an anti-fouling composition.

According to another aspect, the present invention provides a composition comprising a substrate and a plurality of oxide particles, wherein: (i) the plurality of the particles are cross-linked between them and linked to a portion of at least one surface of the substrate; (ii) the plurality of the particles have a median size of 3 nm to 500 nm; and (iii) the plurality of the particles are in the form of a first layer, having a thickness of 0.001 μm to 5.0 μm.

In some embodiments, the plurality of the particles have a median size of about 5 nm to about 150 nm.

In some embodiments, the first layer has a thickness of 1 nm to 450 nm.

In some embodiments, the composition comprises a second layer comprising oxide particles cross-linked between them and linked to the first layer and (iv) one or more hydrophobic agents covalently linked to the oxide particles of the second layer, wherein the composition is characterized by a water contact angle of at least 130°.

In some embodiments, linked is via hydrogen bonds, covalent bonds, or both.

In some embodiments, linked is not obtained using a curing agent.

In some embodiments, the particles have been formed in-situ in contact with the substrate.

In some embodiments, the substrate comprises a polymeric substrate, or a glass substrate.

In some embodiments, the glass substrate is selected from a borosilicate-based glass substrate, silicon-based glass substrate, ceramic-based glass substrate, silica/quartz-based glass substrate, aluminosilicate-based glass substrate, or any combination thereof.

In some embodiments, the polymeric substrate comprises a polymer selected from the group consisting of: polypropylene (PP), polycarbonate (PC), high-density polyethylene (HDPE), low-density polyethylene (LDPE), very low-density polyethylene (VLDPE), polyester, polyethylene terephthalate (PET), polycarbonate (PC), polyvinyl chloride (PVC), polymethyl methacrylate (PMMA), silicon, silicone rubber, polyacetal, cellulose, cellulose derivatives, poly(2-hydroxyethyl methacrylate) (pHEMA), nylon, and any combination thereof.

In some embodiments, the oxide particles are selected from the group consisting of: TiO₂, ZnO, FeO, Fe₂O₃, SiO₂, SiO₂—R, and any combination thereof, wherein R is (CH₂)ₙX, n=1 to 30, and X is a functional group selected from activated double bond, amine, urea, thiourea, melamine, hydantoin, thiol, carboxylate, azide, nitroso, carbonyl, and carboxy.

In some embodiments, the composition further comprises a second layer.

In some embodiments, the second layer comprises SiO₂—R, wherein R is (CH₂)ₙX, n=1 to 30, and X is a functional group selected from activated double bond, amine, urea, thiourea, melamine, hydantoin, thiol, carboxylate, azide, nitroso, carbonyl, and carboxy.

In some embodiments, the second layer comprises one or more hydrophobic agents.

In some embodiments, the one or more hydrophobic agents are covalently linked to the particles.

In some embodiments, the one or more hydrophobic agents comprise an alkylsilane, a fluorolsilane, uridoalkylsilane, or a combination thereof.

In some embodiments, the composition is characterized by a water contact angle on the surface of the second layer of at least 130°.

In some embodiments, the contact angle is in the range of 130° to 165°.

In some embodiments, the substrate has a roughness of 0.5 μm to 15 μm, as measured by Atomic Force Microscope (AFM).

In some embodiments, the first layer further comprises a silane coupling agent.

In some embodiments, the silane coupling agent is selected from the group consisting of: 3-(Methacryloyloxy)propyl]trimethoxy silane (MPS), 3-(aminooxy)propyl]trimethoxysilane (APS), and any combination thereof.

In some embodiments, the 3-(Methacryloyloxy)propyl]trimethoxysilane (MPS) is crosslinked with polyethyleneglycol diacrylate.

In some embodiments, the composition is for use as anti-fogging coatings, superhydrophobic coatings, anti-scratch coatings, sterilization coatings, photochromic coatings, self-cleaning coatings, anti-microbial coatings, anti-fouling coatings, or soil solar disinfection coatings.

In some embodiments, the substrate is or forms a part of an article.

In some embodiments, the article is selected from the group consisting of: transparent plastic surfaces, lenses, a package, and windows.

### BRIEF DESCRIPTION OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

FIGS. 1A-1D present pictures of the optical visibility ranking: transparent continuous layer of water, excellent optical performance (FIG. 1A); large water drops on some parts of the surface allowing partial light transition (FIG. 1B); medium water drops on most of the surface allowing partial light transition (FIG. 1C); small water drops on the whole surface, causing very poor visibility (FIG. 1D).

FIGS. 2A-2B present scanning electron microscope (SEM) images (FIG. 2A) and size histogram (FIG. 2B) of the homo SiO₂ nanoparticles (NPs).

FIGS. 3A-3B present SEM images of polyethylene (PE) film before (FIG. 3A) and after (FIG. 3B) coating with SiO₂ nanoparticles.

FIG. 4 presents Fourier-transform infrared spectroscopy (FTIR) spectra of PE films before and after coating with SiO₂ NPs.

FIG. 5 presents FTIR spectra of PE films before and after coating with SiO₂ NPs of different diameters.

FIGS. 6A-6C present contact angle images of untreated PE film (FIG. 6A), corona treated PE film (FIG. 6B) and PE film coated with SiO₂ NPs (FIG. 6C).

FIG. 7 presents FTIR spectra of PE, SiO₂ coated PE and PE/SiO₂-FTS.

FIGS. 8A-8B present contact angle images of SiO₂ coated PE film before (FIG. 8A) and after (FIG. 8B) binding of 1H,1H,2H,2H-perfluorododecyltrichlorosilane (FTS).

FIGS. 9A-9D present SEM images of a polyethylene terephthalate (PET) film before (FIG. 9A) and after (FIG. 9B) coating with SiO₂ NPs; size histograms (FIG. 9C) and SEM image (FIG. 9D) of the formed homo SiO₂ NPs.

FIGS. 10A-10C present contact angle images of non-treated PET film (FIG. 10A), plasma treated PET film (FIG. 10B), and PET/SiO₂ film (FIG. 10C).

FIGS. 11A-11C present hot fog test images of non-treated PET film (FIG. 11A), plasma treated PET film (FIG. 11B) and PET/SiO₂-24 h film (FIG. 11C), after 3 h of heating in 60° C.

FIGS. 12A-12B present contact angle images of PET/SiO₂ films before (FIG. 12A), and after binding FTS to the PET/SiO₂ films (FIG. 12B).

FIG. 13 presents FTIR spectra of polyvinyl chloride (PVC) films before and after coating with SiO₂NPs.

FIGS. 14A-14D present hot fog test images of PVC/SiO₂ films of samples I (FIG. 14A), II (FIG. 14B), III (FIG. 14C) and non-coated corona treated PVC, IV (FIG. 14D).

FIG. 15A-15B present SEM images of polypropylene (PP) film before (FIG. 15A) and after (FIG. 15B) coating with SiO₂ NPs.

FIG. 16 presents FTIR spectra of PP films before and after coating with SiO₂ NPs.

FIG. 17 presents FTIR spectra of PP, PP/SiO₂ and PP/SiO₂-FTS.

FIGS. 18A-18C present contact angle images of corona treated PP(C) film (FIG. 18A), PP(C)-SiO₂ film (FIG. 18B), and PP(C)-SiO₂-FTS (FIG. 18C).

FIGS. 19A-19C present SEM picture of PP/SiO₂-Urea (FIG. 19A) and EDAX results of the SiO₂-Urea particles attached to the PP film (FIG. 19B and FIG. 19C).

### DETAILED DESCRIPTION OF THE INVENTION

The present invention, in some embodiments thereof, relates to a process for coating a substrate with plurality of inorganic and inorganic-organic hybrid particles, generated in-situ in the presence of the substrate, without the presence of a curing agent. In some embodiments, the inorganic and inorganic-organic hybrid particles are oxide particles. In some embodiments, for successful coatings, the substrate is a hydrophilic substrate, or alternatively, a surface of the substrate is at least partially oxidized to receive hydrophilic groups such as hydroxyl groups.

The present invention, in some embodiments thereof, relates to a composition comprising inorganic and inorganic-organic hybrid nano- or micro-particles grafted to a substrate, processes of preparing such compositions and to uses thereof.

Before explaining at least one embodiment of the invention in detail, it is to be understood that the invention is not necessarily limited in its application to the details set forth in the following description or exemplified by the Examples. The invention is capable of other embodiments or of being practiced or carried out in various ways.

As demonstrated in the examples section, deposition of inorganic or inorganic-organic functional hybrid nano- or micro-particles on variable substrates resulted in imparting advantageous properties to the substrate's surface including any one of antifogging properties, anti-scratching properties, and anti-fouling properties.

### The Process

According to an aspect of some embodiments of the present invention there is provided a process of coating films, (e.g., plastic films) with oxide particles and/or organic-derivatized oxide particles. In some embodiments, the formation of these coated substrates does not require the presence of a film former, surfactant or stabilizer. In some embodiments, the process does not require the presence of a curing agent.

In some embodiments, the process comprises the steps of (i) providing a substrate selected from a hydrophilic substrate, or an at least partially oxidized substrate; and (ii) contacting one or more oxide monomers with the substrate, under conditions suitable for the one or more oxide monomers to polymerize into oxide particles bound to the substrate, thereby coating the substrate with a first layer comprising oxide particles.

In some embodiments, the process comprises contacting one or more oxide monomers with the substrate, during a period of time, thereby polymerizing the one or more oxide monomers in-situ.

In some embodiments, the period of time is a short period of time. In some embodiments, a period of time is less than 10 hours, less than 5 hours, less than 2 hours, less than 1 hour, less than 30 minutes, less than 15 minutes, less than 10 minutes, or less than 5 minutes, including any value therebetween.

In some embodiments, the one or more oxide monomers are in-situ polymerized forming particles. In some embodiments, the particles are generated in-situ in the presence of the substrate. In some embodiments, the in-situ polymerization generates homo particles and grafted particles. In some embodiments, the one or more oxide monomers are silicon oxide monomers.

According to the present invention, the in-situ coating of the oxide compounds may be accomplished in different ways, including but not limited to: dipping the substrate in the oxide-precursor solution, by spraying or spreading the oxide solution via a mayer rod onto a corona, or O₂ plasma treated film.

In some embodiments, the process further comprises a step (iii) of washing the substrate to remove non-bound oxide particles.

In some embodiments, the process further comprises a step (iv) contacting one or more oxide monomers with the substrate under conditions suitable for the one or more oxide monomers to polymerize into oxide particles bound to the first layer, thereby forming a second layer over the first layer.

In some embodiments, contacting is via dipping, spraying, spreading, curing, or printing.

In some embodiments, the one or more oxide monomers have a general formula of M(OR)₄, M(R′)ₙ(OR)₄₋ₙ, or a combination thereof, wherein M is a metal selected from Si, Ti, Zn, or Fe, and R and R′ are each independently selected from hydrogen, methyl, alkyl, alkenyl, alkynyl, cycloalkyl, heteroalicyclic, aryl, heteroaryl, hydroxy, alkoxy, aryloxy, thiohydroxy, thioalkoxy, thioaryloxy, halide, amine, amide, carbonyl, thiocarbonyl, carboxy, thiocarboxy, epoxide, sulfonate, sulfonyl, sulfinyl, sulfonamide, nitro, nitrile, melamine, isonitrile, thiirane, aziridine, nitroso, hydrazine, sulfate, azide, phosphonyl, phosphinyl, urea, thiourea, carbamyl and thiocarbamyl.

In some embodiments, the substrate comprises a polymeric substrate, or a glass substrate.

Non-limiting examples of glass substrates according to the present invention comprise borosilicate-based glass substrate, silicon-based glass substrate, ceramic-based glass substrate, silica/quartz-based glass substrate, aluminosilicate-based glass substrate, and any combination thereof.

Non-limiting examples of polymeric substrates according to the present invention comprise polypropylene (PP), polycarbonate (PC), high-density polyethylene (HDPE), low-density polyethylene (LDPE), very low-density polyethylene (VLDPE), polyester, polyethylene terephthalate (PET), polycarbonate (PC), polyvinyl chloride (PVC), polymethyl methacrylate (PMMA), silicon, polyacetal, silicone rubber, cellulose, cellulose derivatives, poly(2-hydroxyethyl methacrylate) (pHEMA), nylon, and any combination thereof.

In some embodiments, the oxide monomers are in a solution comprising a protic solvent. In some embodiments the protic solvent is selected from the group consisting of: water, ethanol, methyl ethyl ketone, isopropanol, methanol, butanol and a combination thereof. In some embodiments, the solution is devoid of a curing agent, a film former, a surfactant, or a stabilizer.

As described herein throughout the particles are micro sized or nano sized.

In some embodiments, the step of contacting the substrate and the monomers in aqueous/organic medium, is performed at room temperature (e.g., about 25° C.),

In some embodiments, the medium comprising the substrate and the particles is shaken or incubated up to 24 h. In some embodiments, the medium comprising the substrate and the particles is shaken or incubated up to 18 h. In some embodiments, the medium comprising the substrate and the particles is shaken or incubated up to 10 h. In some embodiments, the medium comprising the substrate and the particles is shaken or incubated up to 1 h. In some embodiments, the medium comprising the substrate and the particles is shaken or incubated up to 10 min. In some embodiments, the medium comprising the substrate and the particles is shaken or incubated up to 2 min. In some embodiments, the medium comprising the substrate and the particles is shaken or incubated up to 1 min. In some embodiments, the medium comprising the substrate and the particles is shaken or incubated up to 05 min.

In some embodiments, the resulting coated films are washed with an organic solvent and air-dried.

In some embodiments, the coating process further comprises a step of evaporating the solvent(s) mixture or coating (e.g., the mixture or coating deposited on the film). The step of evaporating the solvent(s) may be performed at e.g., room temperature (i.e. 15° C. to 30° C.) or at elevated temperature (i.e. up to 100° C.).

According to an aspect of some embodiments of the present invention there is provided a process of coating a substrate with metal oxide particles. As described hereinabove, the substrate may be in form of a film.

In some embodiments, prior to the coating process, the surface of the substrate is treated by methods known in the art, such as, and without being limited thereto, plasma treatment, UV-ozone treatment, or corona discharge. Various embodiments of the film and the primer are described hereinabove.

In some embodiments, the organic solvent(s), suspension, or solution comprise, without being limited thereto, ethanol, isopropanol, methanol, butanol, pentanol, water or any mixture or combination thereof.

In some embodiments, various silica precursor may be used to obtain SiO₂ and/or organic-derivatized SiO₂. In some embodiments, silicon alkoxide may be used. The example of silicon alkoxide may include a compound of the formula: Si(OR¹)₄, where the R¹ may be C₁-C₆ alkyl, alkenyl or aromatic group, substituted or unsubstituted with halogen atom. The silicon alkoxide may include without being limited thereto, TEOS (tetraethyl orthosilicate), TMOS (tetramethyl orthosilicate), TBOS (tetrabutyl orthosilicate). In some embodiments, silica precursors may include without being limited thereto, silicon halide or silicon salt.

In some embodiments, solution further comprises a silane coupling agent.

In some embodiments, the oxide monomer and the silane coupling agent are in a ratio of e.g., 95:5, 93:7, 90:10, 80:20, 70:30, 60:40, 50:50, 40:60, 30:70, 20:80, 10:90, or 5:95, respectively including any value and range therebetween.

In some embodiments, the silane coupling agent is selected from, without being limited thereto, a monohalosilane, a dihalosilane, a trihalosilane, a monoalkoxysilane, a dialkoxysilane, and a trialkoxysilane; and wherein the monohalosilane, dihalosilane, trihalosilane, monoalkoxysilane, dialkoxysilane, and trialkoxysilane are functionalized with a moieties selected from an amine, a methacrylate, an acrylate, a styrenic, an epoxy, an isocyanate, a halogen, an alcohol, a benzophenone derivative, a maleimide, a carboxylic acid, an ester, an acid chloride, and an olefin.

In some embodiments, the silane coupling agent is selected from, without being limited thereto, 3-(Methacryloyloxy)propyl]trimethoxysilane (MPS), 3-(aminooxy)propyl]trimethoxysilane (APS), uridopropyltrimethoxysilane, trialkylpropypylmelaminesilane, triethoxysilylpropyl hydantoin and any combination thereof.

According to an aspect of some embodiments of the present invention there is provided a process for receiving a composition comprising a substrate and a plurality of oxide particles linked to a portion of at least one surface of the substrate, characterized by a water contact angle of at least 130°.

According to an aspect of some embodiments of the present invention there is provided a process for receiving a scratch resistant composition.

According to an aspect of some embodiments of the present invention there is provided a process for receiving an anti-fouling composition.

According to another aspect of some embodiments of the present invention there is provided a process for the preparation of derivatized and/or stabilized silica coatings e.g., with a polymeric material, by curing e.g., UV curing. In some embodiments, the UV curing may be performed for 05. min 1 min, 30 min, 1 h, 2 h, 3 h, 4 h, 5 h, 6 h, 7 h, 8 h, 9 h, 10 h, 11 h, 12 h, 13 h, 14 h, 15 h, 16 h, 17 h, 18 h, 19 h, 20 h, 21 h, 22 h, 23 h, 24 h, including any value and range therebetween.

In some embodiments, the process comprises a step of mixing a photo-initiator and a crosslinker in an organic solvent.

In some embodiments, the photo-initiator is selected from, without being limited thereto, 2,6-bis(4-azidobenzylidene)cyclohexanone; 2,6-bis(4-azidobenzylidene)-4-methylcyclohexanone; 4,4-diazidostilbene-2,2′-disulfonic acid disodium salt; ammonium dichromate; 1-hydroxy-cyclohexyl-pentyl-keton (Irgacure 907); 2-methyl-1[4-(methylthio)phenyl]-2-morpholinopropane-1-one (Irgacure 184C); 2-hydroxy-2-methyl-1-phenyl-propane-1-one (Darocur 1173); a mixed photo-initiator (Irgacure 500) of 50 wt % of Irgacure 184C and 50 wt % of benzophenone; a mixed initiator (Irgacure 1000) of 20 wt % of Irgacure 184C and 80 wt % of Darocur 1173; 2-hydroxy-1-[4-(2-hydroxyethoxy)phenyl]-2-methyl-1-propanone (Irgacure 2959); methylbenzoylformate (Darocur MBF); alpha, alpha-dimethoxy-alpha-phenylacetophenone (Irgacure 651); 2-benzyl-2-(dimethylamino)-1-[4-(4-morpholinyl)phenyl]-1-butanone (Irgacure 369); a mixed initiator (Irgacure 1300) of 30 wt % of Irgacure 369 and 70 wt % of Irgacure 651; diphenyl (2,4,6-trimethylbenzoyl)-phosphine oxide (Darocur TPO); a mixed initiator (Darocur 4265) of 50 wt % of Darocur TPO and 50 wt % of Darocur 1173; a phosphine oxide; phenyl bis(2,4,6-trimethyl benzoyl) (Irgacure 819); a mixed initiator (Irgacure 2005) of 5 wt % of Irgacure 819 and 95 wt % of Darocur 1173; a mixed initiator (Irgacure 2010) of 10 wt % of Irgacure 819 and 90 wt % of Darocur 1173; a mixed initiator (Irgacure 2020) of 20 wt % of Irgacure 819 and 80 wt % of Darcocur 1173; bis (etha 5-2,4-cyclopentadiene-1-yl) bis[2,6-difluoro-3-(1H-pyrrole-1-yl)phenyl]titanium (Irgacure 784); a mixed initiator containing benzophenone(HSP 188); and derivatives thereof.

As used herein, the term “silane” refers to monomeric silicon compounds with four substituents, or groups, attached to the silicon atom. These groups can be the same or different and nonreactive or reactive, with the reactivity being inorganic or organic.

By “silane derivative” or “silane coupling agent” is meant a silane having at least one chemical moiety that does participate in polymerization of the silane. This chemical moiety may have a reactive functional group to attach other chemical species to the silane monomer or polymer, e.g., organic molecules.

As used herein, “crosslinked” and/or “crosslinking”, and any grammatical derivative thereof refers generally to a chemical process or the corresponding product thereof in which two chains of polymeric molecules are attached by bridges (crosslinker) composed of an element, a group or a compound, which join certain carbon atoms of the chains by primary chemical.

As used herein, “crosslinker” can be any molecule that is hydrophilic and has a plurality of polymerizable groups. In some embodiments, the cross-linker is a degradable (e.g. biodegradable) cross-linker, including those containing disulfide bonds, ester bonds, carbonate bonds, amide bonds, or other bonds in the crosslinker backbone that may be cleaved.

In some embodiments, the crosslinker is selected from, without being limited thereto, polyethylene glycol (PEG), polyethyleneglycol diacrylate (PEGDA). ethylene glycol dimethacrylate (EGDMA); methacryloyloxyethyl-N-(2-methacryloyloxyethyl phosphorylcholine); di-, tri-, tetra-, penta-, and hexa(ethylene glycol) dimethacrylate; “Medium” length PEG crosslinkers, such as PEG diacrylates or PEG dimethacrylates with molecular weights ranging from 500 to 50,000 Da (e.g., 500, 1,000, 2,000, 3,400, 5,000, 10,000, 20,000, and 50,000 Da). In some embodiments, the cross-linker is methylene bisacrylate, methylene bisacrylamide, methylene bismethacrylate, or methylene bismethacrylamide.

The term “UV curing” is used herein to mean a process in which ultraviolet light and visible light are used to initiate a photochemical reaction that generates a crosslinked network of polymers.

Exemplary extrusion process and parameter relating thereof is described herein below under the Example section.

### The Compositions-of-Matter

According to one aspect, there is provided a composition comprising a substrate and a plurality of oxide particles. In some embodiments, the composition is hydrophilic.

According to one aspect, there is provided a composition comprising a plurality of oxide particles, wherein the plurality of the particles are cross-linked between them and linked to a portion of at least one surface of the substrate. In some embodiments, the plurality of the particles have a median size of 3 nm to 500 nm. In some embodiments, the plurality of the particles are in the form of a first layer, having a thickness of 0.005 μm to 5.0 μm. In some embodiments, the particles have a median size of 5 nm to 150 nm.

In some embodiments, linked is covalently. In some embodiments, linked is physically. In some embodiments, linked is a stable and non-migrated bonding. In some embodiments, non-migrated bonding refers to the fact that the particles are strongly bound to the substrate surface and not able to move through the surface, as opposed to previous known methods using curing agents.

In some embodiments, the composition-of-matter comprises one or more particles.

In some embodiments, the oxide particles are microsized. In some embodiments, the particles are nanosized or mixed.

In some embodiments, the average or median size (e.g., diameter, length) ranges from about 0.0005 micrometer to 5 micrometers.

In some embodiments, the average or median size is about 5 nm, 10 nm, 70 nm, 0.15 μm, about 0.2 μm, about 0.3 μm, about 0.4 μm, or about 5 μm, including any value and size range therebetween.

In some embodiments, the size of at least 90% of the particles varies within a range of less than ±25%, and the plurality of the particles are in the form of a first layer, the first layer having a thickness of 0.005 μm to 5.0 μm. In some embodiments, the composition is characterized by a water contact angle on a surface of the first layer of less than 70°.

In some embodiments, the composition is characterized by a water contact angle on a surface of the first layer of less than 70°, less than 68°, less than 65°, less than 50°, less than 40°, less than 30°, less than 20°, less than 10°, or less than 5°, including any value therebetween.

In some embodiments, the composition is characterized by a water contact angle on a surface of the first layer in the range of 5° to 70°, 8° to 70°, 10° to 70°, 12° to 70°, 15° to 70°, 5° to 68°, or 5° to 60°, including any range therebetween.

In some embodiments, the present invention provides a composition with anti-fogging properties.

According to some embodiments, the present invention provides an abrasion resistant composition. In some embodiments, the present invention provides a composition with improved abrasion resistance.

As used herein, the term “abrasion resistance” refers to the ability of a material to stop the displacement when exposed to a relative movement of the hard particles or projections. Displacement is visually observed to be typically the bottom surface exposed by the removal of the coating material. Abrasion resistance can be measured through a variety of tests known in the art, such as for example, burned off (Taber) wear test, Gardner scrubber (Gardner scrubber) test, a sand-fall (falling sand) tests.

According to some embodiments, the present invention provides a scratch resistant composition. In some embodiments, the present invention provides a scratch resistant composition comprising a substrate and a plurality of oxide particles, wherein: (i) the plurality of the particles are cross-linked between them and linked to a portion of at least one surface of the substrate; (ii) the plurality of the particles have a median size of 5 nm to 500 nm; and (iii) the plurality of the particles are in the form of a first layer, the first layer having a thickness of 1 nm to 450 nm.

In some embodiments, the first layer has a thickness of 1 nm to 440 nm, 1 nm to 430 nm, 1 nm to 420 nm, 1 nm to 400 nm, 1 nm to 390 nm, 1 nm to 350 nm, 1 nm to 300 nm, 1 nm to 290 nm, 1 nm to 250 nm, 1 nm to 200 nm, 5 nm to 440 nm, 10 nm to 440 nm, 20 nm to 440 nm, 50 nm to 440 nm, 5 nm to 350 nm, 5 nm to 300 nm, 5 nm to 290 nm, or 5 nm to 250 nm, including any range therebetween.

According to some embodiments, the present invention provides a superhydrophobic composition. In some embodiments, the present invention provides a composition comprising (i) a substrate, (ii) a first layer comprising oxide particles cross-linked between them and linked to at least a portion of a surface of the substrate, (iii) a second layer comprising oxide particles cross-linked between them and linked to the first layer and (iv) one or more hydrophobic agents covalently linked to the oxide particles of the second layer, wherein the composition is characterized by a water contact angle of at least 130°. In some embodiments, the composition is characterized by a water contact angle in the range of 130° to 180°, 130° to 168°, 130° to 165°, 130° to 160°, 140° to 180°, or 150° to 168°, including any range therebetween.

In some embodiments, linked is via hydrogen bonds, covalent bonds, or both. In some embodiments, linked is not obtained using a curing agent.

As used herein, the term “curing agent” refers to a substance typically added to a surface to facilitate the bonding of molecular components to the surface.

In some embodiments, the particles have been formed in-situ in contact with the substrate.

Herein throughout, the terms “nanoparticle”, “nano”, “nanosized”, and any grammatical derivative thereof, which are used herein interchangeably, describe a particle featuring a size of at least one dimension thereof (e.g., diameter, length) that ranges from about 1 nanometer to 100 nanometers. Herein throughout, “NP(s)” designates nanoparticle(s).

In some embodiments, the size of the particles described herein represents an average or median size of a plurality of nanoparticle composites or nanoparticles.

In some embodiments, the average or the median size of at least e.g., 10%, 20%, 30%, 40%, 50%, 60%, 70%, 80%, 90%, or 95% of the particles, ranges from: about 1 nanometer to 1000 nanometers, or, in other embodiments from 1 nm to 500 nm, or, in other embodiments, from 5 nm to 200 nm. In some embodiments, the average or the median size ranges from about 1 nanometer to about 300 nanometers. In some embodiments, the average or the median size ranges from about 1 nanometer to about 200 nanometers. In some embodiments, the average or the median size ranges from about 1 nanometer to about 100 nanometers. In some embodiments, the average or the median size ranges from about 1 nanometer to 50 nanometers, and in some embodiments, it is lower than 35 nm.

In some embodiments, a plurality of the particles has a uniform size.

By “uniform” or “homogenous” it is meant to refer to size distribution that varies within a range of less than e.g., ±60%, ±50%, ±40%, ±30%, ±20%, or ±10%, including any value therebetween.

In some embodiments, plurality of the particles is characterized by an average hydrodynamic diameter of less than 30 nm with a size distribution of that varies within a range of less than e.g., 60%, 50%, 40%, 30%, 20%, or 10%, including any value therebetween.

In some embodiments, the particles size is about 1 nm, about 2 nm, about 3 nm, about 4 nm, about 5 nm, about 6 nm, about 7 nm, about 8 nm, about 9 nm, about 10 nm, about 11 nm, about 12 nm, about 13 nm, about 14 nm, about 15 nm, about 16 nm, about 17 nm, about 18 nm, about 19 nm, about 20 nm, about 21 nm, about 22 nm, about 23 nm, about 24 nm, about 25 nm, about 26 nm, about 27 nm, about 28 nm, about 29 nm, about 30 nm, about 31 nm, about 32 nm, about 33 nm, about 34 nm, about 35 nm, about 36 nm, about 37 nm, about 38 nm, about 40 nm, about 42 nm, about 44 nm, about 46 nm, about 48 nm, or 50 nm, including any value therebetween.

As used herein the terms “average” or “median” size refer to diameter of the polymeric particles. The term “diameter” is art-recognized and is used herein to refer to either of the physical diameter (also termed “dry diameter”) or the hydrodynamic diameter. As used herein, the “hydrodynamic diameter” refers to a size determination for the composition in solution (e.g., aqueous solution) using any technique known in the art, e.g., dynamic light scattering (DLS).

As exemplified in the Example section that follows, the dry diameter of the polymeric particles, as prepared according to some embodiments of the invention, may be evaluated using transmission electron microscopy (TEM) or scanning electron microscopy (SEM) imaging.

The particle(s) can be generally shaped as a sphere, incomplete-sphere, particularly the size attached to the substrate, a rod, a cylinder, a ribbon, a sponge, and any other shape, or can be in a form of a cluster of any of these shapes, or can comprises a mixture of one or more shapes.

As used herein throughout, the term “polymer” describes an organic substance composed of a plurality of repeating structural units (backbone units) covalently connected to one another.

### Substrates

In some embodiments a plurality of oxide particles as described in any of the respective embodiments is incorporated in and/or on at least a portion of the substrate.

In some embodiments a plurality of oxide particles as described in any of the respective embodiments is incorporated in and/or on at least a portion of at least one surface of the substrate.

According to an aspect of some embodiments of the present invention, there is provided a substrate having incorporated in and/or on at least a portion thereof the disclosed particles as described herein.

By “a portion thereof” it is meant, for example, a surface or a portion thereof, and/or a body or a portion thereof, of solid or semi-solid substrates; or a volume or a part thereof, of liquid, gel, foams and other non-solid substrates.

In some embodiments, the substrate is at least partially hydrophilic. In some embodiments, the substrate is a hydrophilic substrate.

In some embodiments, the substrate is at least partially oxidized.

In some embodiments, the substrate comprises a glass substrate.

Non-limiting examples of glass substrates according to the present invention comprise: borosilicate-based glass substrate, silicon-based glass substrate, ceramic-based glass substrate, silica/quartz-based glass substrate, aluminosilicate-based glass substrate, or any combination thereof.

In some embodiments, the substrate comprises a polymeric substrate.

In some embodiments, a polymeric substrate comprises a polymer selected from the group consisting of: polypropylene (PP), polycarbonate (PC), high-density polyethylene (HDPE), low-density polyethylene (LDPE), very low-density polyethylene (VLDPE), polyester, polyethylene terephthalate (PET), polycarbonate (PC), polyvinyl chloride (PVC), polymethyl methacrylate (PMMA), silicon, silicone rubber, polyacetal, cellulose, cellulose derivatives, poly(2-hydroxyethyl methacrylate) (pHEMA), nylon, and any combination thereof.

Substrate usable according to some embodiments of the present invention can therefore be hard (rigid) or soft, solid, semi-solid, or liquid substrates, and may take a form of a foam, a solution, an emulsion, a lotion, a gel, a cream or any mixture thereof.

Substrate usable according to some embodiments of the present invention can have, for example, organic or inorganic surfaces, including, but not limited to, glass surfaces; porcelain surfaces; ceramic surfaces; silicon or organosilicon surfaces, metallic surfaces (e.g., stainless steel); mica, polymeric surfaces such as, for example, plastic surfaces, rubbery surfaces, paper, wood, polymer, a metal, carbon, a biopolymer, silicon mineral (rock or glass), surfaces, wool, silk, cotton, hemp, leather, fur, feather, skin, hide, pelt or pelage) surfaces, plastic surfaces and surfaces comprising or made of polymers such as but not limited to polypropylene (PP), polycarbonate (PC), polyethylene (PET), high-density polyethylene (HDPE), low-density polyethylene (LDPE), very low-density polyethylene (VLDPE), polyester (PE), polymethylmethacrylate (PMMA), polystyrene, unplasticized polyvinyl chloride (PVC), and fluoropolymers including but not limited to polytetrafluoroethylene (PTFE, Teflon®), polyacetal, and nylon; or can comprise or be made of any of the foregoing substances, or any mixture thereof.

Substrates of widely different chemical nature can be successfully utilized for incorporating (e.g., depositing on a surface thereof) the disclosed polymeric particles thereon, as described herein. By “successfully utilized” it is meant that (i) the disclosed polymeric particles successfully form a uniform and homogenously coating on the substrate's surface; and (ii) the resulting coating imparts long-lasting desired properties to the substrate's surface.

### First Layer of Oxide Particles on a Substrate

According to one aspect, there is provided a composition comprising a substrate (e.g., a partially oxidized) and a plurality of particles, wherein the plurality of the particles are linked to a portion of (and/or at least one surface of) the substrate, in the form of a first layer. In some embodiments, the first layer comprises oxide particles. In some embodiments, the first layer comprises derivatized oxide particles. In some embodiments, the derivatized oxide particles comprise terminal functional groups, such as urea and/or amide functional groups.

In some embodiments the disclosed polymeric particles form a layer (referred to herein as “first layer”) thereof in/on a surface the substrate.

In some embodiments, in the composition comprising a substrate, the particles represent a surface coverage referred to as “first layer” e.g., 100%. In some embodiments, the particles represent about 90% of surface coverage, about 80%, about 70%, about 60%, about 50%, about 40%, including any value therebetween. In some embodiments the first layer composed of a surface-tighten layer composed of smaller particles than those above.

In some embodiments, the particles comprise oxide particles.

In some embodiments, the particles comprise metal-oxide particles.

In some embodiments, the oxide particles are selected from the group consisting of TiO₂, ZnO, FeO, Fe₂O₃, SiO₂, SiO₂—R, and any combination thereof, wherein R is (CH₂)ₙX, n=1 to 30, and X is a functional group selected from activated double bond, amine, urea, thiourea, melamine, hydantoin, thiol, carboxylate, azide, nitroso, carbonyl, and carboxy.

In some embodiments, the first layer comprises a first sub-layer of oxide particles and a second sub-layer of oxide particles.

In some embodiments, the first sub-layer is linked to a portion of at least one surface of the substrate. In some embodiments, the first sub-layer is linked to 20% to 100%, 20% to 80%, 50% to 100%, 70% to 99%, or 70% to 100%, of the area of at least one surface of the substrate, including any range therebetween.

In some embodiments, the second sub-layer is an outer layer to the first sub-layer.

The metal oxide nanoparticles may be prepared by a variety of known methods. In one embodiment, the metal oxide nano/micro-particles may be prepared from a metal oxide precursor according to a gas phase method, a liquid phase method, or a solid phase method. In other embodiments, a sol-gel process, hydrothermal process, microemulsion synthesis, or the like, may be used, and accordingly, the claimed subject matter is not limited in this respect.

In some embodiments, the composition further comprises a coupling agent mixed with or attached to the oxide particles in the first layer.

In some embodiments, the term “coupling agent” refers to a silane coupling agents of the type [R¹—Si(OR²)₃], wherein R¹ is a functional group, such as but not limited to aminopropyl, mercaptopropyl, ureapropyl, melamine propyl or acrylate propyl and R² is a methyl or ethyl group, or other group used in the preparation of hybrid silica-polymer materials for high performance coatings.

The “coupling agent” may be used separately or together with the tetralkylsilane compound, e.g., Si(OEt)₄ to form the first layer

The coupling agent, e.g. uridopropyltrimethoxysilane, can also be in situ polymerized on the substrate in absence of the tetralkylsilane compound to form the first layer.

In some embodiments, a crosslinker is further attached to the coupling agent.

Further embodiments of the coupling agent and crosslinker are further described in the process section bellow.

The terms, film/films and layer/layers are used herein interchangeably. As used herein, the term “coat” refers to the combined layers disposed over the substrate, excluding the substrate, while the term “substrate” refers to the part of the composite structure supporting the disposed layer/coating. In some embodiments, the terms “layer”, “film” or as used herein interchangeably, refer to a substantially uniform-thickness of a substantially homogeneous substance.

The chemistry and morphological properties of the layers, e.g., disposed on top of the substrate, are discussed herein below in the Example section. Moreover, according to one embodiment of the present invention, the layer is homogenized deposited on a surface.

In some embodiments, the desired dry thickness of the first layer of the disclosed polymer is characterized by a thickness of 0.001 to 5 microns. For example, the thickness of the dry layer may be from about 0.05 microns to about 2 microns. In some embodiments, the dry layer thickness is up to about 50 microns, however thicker or thinner layers can be achieved.

In exemplary embodiments, the dry layer is characterized by a thickness of 0.001 μm, 0.005 μm, 0.01 μm, 0.1 μm, 0.2 μm, 0.3 μm, 0.4 μm, 0.5 μm, 0.6 μm, 0.7 μm, 0.8 μm, 0.9 μm, 1.0 μm, 1.1 μm, 1.2 μm, 1.3 μm, 1.4 μm, or 1.5 μm, 1.6 μm, 1.7 μm, 1.8 μm, 1.9 μm, 2.0 μm, 2.1 μm, 2.2 μm, 2.3 μm, 2.4 μm, 2.5 μm, 2.6 μm, 2.7 μm, 2.8 μm, 2.9 μm, 3.0 μm, 3.1 μm, 3.2 μm, 3.3 μm, 3.4 μm, 3.5 μm, 3.6 μm, 3.7 μm, 3.8 μm, 3.9 μm, 4.0 μm, 4.1 μm, 4.2 μm, 4.3 μm, 4.4 μm, 4.5 μm, 4.6 μm, 4.7 μm, 4.8 μm, 4.9 μm, or 5.0 μm, including any value therebetween.

In some embodiments, the term “dry layer thickness” as used herein refers to the layer thickness obtained by storing the composite at room conditions (e.g., at 25° C. and humidity of up to e.g., 60% and measuring the thickness thereof under that condition).

In some embodiments, the wet thickness is characterized by 0.005 to 20.0 microns. In exemplary embodiments, the wet layer thickness is characterized by a thickness of 0.01 μm, 0.5 μm, 1.0 μm, 2 μm, 3 μm, 4 μm, 5 μm, 6 μm, 7 μm, 8 μm, 9 μm, 10 μm, 11 μm, 12 μm, 13 μm, 14 μm, 15 μm, 16 μm, 17 μm, 18 μm, 19 μm, or 20 μm, including any value therebetween.

Wet thickness is the thickness as measured after adding a liquid has been added to the composition, as described in the example section below.

### Second Layer

In some embodiments one or more hydrophobic agents are covalently linked to the disclosed polymeric particles (“first layer”) forming a “second layer”.

In some embodiments, a composition as described herein comprises a second layer. In some embodiments, a composition as described herein comprises a second layer comprising one or more coupling agents, one or more hydrophobic agents, or a combination thereof.

The hydrophobic agents include, without being limited thereto, Silicon-based hydrophobic agents such as siloxane, silane, silicone or a combination thereof; Fluorine-based hydrophobic agents such as fluorosilane, uridoalkylsilane, fluoroalkylsilane (FAS), polytetrafluoroethylene (PTFE), polytrifluoroethylene, polyvinyl fluoride, or functional fluoroalkyl compounds or a combination thereof; Carbohydrate hydrophobic agents or hydrocarbon hydrophobic agents such as reactive wax, polyethylene, polypropylene, or a combination thereof.

In some embodiments, the hydrophobic agents include, a functional silane compound polymerized on the first layer. In some embodiments, a functional silane compound refers to a silane containing activated double bond/s, urea functionality or amide functionality.

In some embodiments, the second layer comprises SiO₂—R, wherein R is (CH₂)ₙX, n=1 to 30, and X is a functional group selected from activated double bond, amine, urea, thiourea, melamine, hydantoin, thiol, carboxylate, azide, nitroso, carbonyl, and carboxy.

In some embodiments, a composition according to the present invention comprising a second layer is characterized by a water contact angle on the surface of the second layer of at least 130°. In some embodiments, the contact angle is in the range of 130° to 165°. In some embodiments, the composition is characterized by a water contact angle in the range of 130° to 160°, 140° to 165°, or 150° to 165°, including any range therebetween.

According to one aspect, there is provided a composition for use as any one of anti-fogging coatings, superhydrophobic coatings, anti-scratch coatings, sterilization coatings, photochromic coatings, self-cleaning coatings, anti-microbial coatings, anti-fouling coatings, or soil solar disinfection coatings, and combinations thereof.

In some embodiments, the coupling agents containing amide groups (e.g., ureidopropyltrialkylsilane) or melamines are used for preparing halamines for anti-fouling and self-cleaning applications.

In some embodiments, chloramine derivatized coatings for anti-fouling purposes are prepared by chlorination of the urea-derivatized coatings.

In some embodiments, chloramine derivatized coatings for self-cleaning purposes are prepared by chlorination of the urea-derivatized coatings.

### Articles

In some embodiments, the substrate incorporating the polymer as described herein is or forms a part of an article.

Hence according to an aspect of some embodiments of the present invention there is provided an article (e.g., an article-of-manufacturing) comprising a substrate incorporating in and/or on at least a portion thereof a composition-of-matter or the crosslinked polymer, as described in any one of the respective embodiments herein.

In some embodiments, the article is selected from the group consisting of: transparent plastic surfaces, lenses, a package, and windows.

In some embodiments, the article-of-manufacturing includes a sealing part, for example, O-rings, and the like.

In some embodiments, the article is, for example, article having a corrosivable surface.

In some embodiments, the article is an agricultural device.

In some embodiments, the article of manufacture is a construction element, such as, but not limited to, paints, walls, windows, door handles, and the like.

In some embodiments, the article according to the invention may be any optical article that may encounter a problem of fog formation, such as a screen, a glazing for the automotive industry or the building industry, or a mirror, it is preferably an optical lens, more preferably an ophthalmic lens, for spectacles, or a blank for optical or ophthalmic lenses.

The article can be any article which can benefit from the anti-fogging, superhydrophobic, anti-fouling, soil solar disinfection activities of the disclosed polymeric particles.

The term “anti-fog”, and the like are used herein to indicate a composition or a compound that is capable of providing antifogging properties on at least one portion thereof. In the context of the disclosed polymeric particles deposited on or incorporated within a substrate, this term is meant to refer to the antifogging properties being imparted on at least one surface of the substrate.

Antifogging properties may be characterized by e.g., roughness, contact angle, haze and gloss or by a combination thereof.

By “antifogging properties” it is meant to refer, inter alia, to the capability of a substrate's surface to prevent water vapor from condensing onto its surface in the form of small water drops redistributing them in the form of a continuous film of water in a very thin layer.

The term “roughness” as used herein relates to the irregularities in the surface texture. Irregularities are the peaks and valleys of a surface.

In some embodiments, the surface is characterized by a roughness of e.g., 0.5 μm, 1.0 μm, 1.5 μm, 2.0 μm, 2.5 μm, 3.0 μm, 3.5 μm, 4.0 μm, 4.5 μm, 5.0 μm, 5.5 μm, 6.0 μm, 6.5 μm, 7.0 μm, 7.5 μm, 8.0 μm, 8.5 μm, 9.0 μm, 9.5 μm, 10.0 μm, 10.5 μm, 11.0 μm, 11.5 μm, 12.0 μm, 12.5 μm, 13.0 μm, 13.5 μm, 14.0 μm, 14.5 μm, or 15.0 μm, including any value therebetween, as measured by Atomic Force Microscope (AFM).

In some embodiments of the invention, the composition or article disclosed herein exhibit an increased antifogging effect with time.

In some embodiments, the degree of the antifogging property is correlated with the wettability of a surface. Wettability of a surface is typically and acceptably determined by contact angle measurements of aqueous liquids, as is further detailed in the Example section herein below.

Herein, substrate's surface is considered wettable when it exhibits a static contact angle e.g., on the surface of the first layer of less than e.g., 70°, 60°, 50°, 40°, 30°, 20°, 10°, 9°, 8°, 7°, 6° or 5°, with an aqueous liquid.

In some embodiments, the film coated with the particles is characterized by a contact angle, having a value of e.g., 90%, 80%, 70%, 60%, 50%, 40%, 30%, 20%, 10%, 5%, or 1%, of the contact angle of a control material (e.g., non-coated substrate).

The term “hydrophobic surface” is one that results in a water droplet forming a surface contact angle exceeding about 90° and less than about 150° at room temperature (about 18 to about 23° C.).

The term “superhydrophobic surface” is defined as surfaces which have a water contact angle above 150° but less than the theoretical maximum contact angle of about 180° at room temperature. In nature, lotus leaves are considered super hydrophobic. Water drops roll off the leaves collecting dirt along the way to give a “self-cleaning” surface.

In some embodiments of the invention, the composition or the article disclosed herein exhibits a contact angle on the surface of the second layer of at least 130°, 140°, 150°, 160°, 165° with an aqueous liquid, or any value therebetween.

The term “anti-biofouling” or “anti-biofouling activity” is referred to as an ability to inhibit (prevent), reduce or retard biofilm formation on a substrate's surface.

The term “soil solar disinfection activities” refers to environmentally friendly methods of using solar power for controlling pests such as soil borne plant pathogens including fungi, bacteria, nematodes, and insect and mite pests along with weed seed and seedlings in the soil by mulching the soil and covering it with tarp, usually with a transparent polyethylene cover, to trap solar energy. It may also describe methods of decontaminating soil using sunlight or solar power.

Exemplary articles include, but are not limited to, medical devices, organic waste processing device, fluidic device, an agricultural device, a package (e.g., a food packaging), a sealing article, a fuel container, a water and cooling system device and a construction element.

Non-limiting examples of devices which can incorporate the disclosed composition, as described herein, beneficially, include tubing, pumps, drain or waste pipes, screw plates, and the like.

In some embodiments, the article is an element used in water treatment systems (such as for containing and/or transporting and/or treating aqueous media or water), devices, containers, filters, tubes, solutions and gases and the likes.

### General

As used herein the term “about” refers to ±15%.

The terms “comprises”, “comprising”, “includes”, “including”, “having” and their conjugates mean “including but not limited to”. The term “consisting of” means “including and limited to”. The term “consisting essentially of” means that the composition, method or structure may include additional ingredients, steps and/or parts, but only if the additional ingredients, steps and/or parts do not materially alter the basic and novel characteristics of the claimed composition, method or structure.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

As used herein, the singular form “a”, “an” and “the” include plural references unless the context clearly dictates otherwise. For example, the term “a compound” or “at least one compound” may include a plurality of compounds, including mixtures thereof.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible sub ranges as well as individual numerical values within that range. For example, description of a range such as from 1 to 6 should be considered to have specifically disclosed sub ranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

As used herein the term “method” refers to manners, means, techniques and procedures for accomplishing a given task including, but not limited to, those manners, means, techniques and procedures either known to, or readily developed from known manners, means, techniques and procedures by practitioners of the chemical, pharmacological, biological, biochemical and medical arts.

As used herein, the term “treating” includes abrogating, substantially inhibiting, slowing or reversing the progression of a condition, substantially ameliorating clinical or aesthetical symptoms of a condition or substantially preventing the appearance of clinical or aesthetical symptoms of a condition.

In those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.).

It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub combination or as suitable in any other described embodiment of the invention. Certain features described in the context of various embodiments are not to be considered essential features of those embodiments, unless the embodiment is inoperative without those elements.

Various embodiments and aspects of the present invention as delineated hereinabove and as claimed in the claims section below find experimental support in the following examples.

### EXAMPLES

Reference is now made to the following examples, which together with the above descriptions illustrate some embodiments of the invention in a non-limiting fashion.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

### Example 1

### Materials and Methods

### Chemicals

The following analytical-grade chemicals were purchased from Aldrich and used without further purification: ethanol (HPLC), isopropanol, ammonium hydroxide (NH4OH, 28%), sodium hipochloride, (NaOCl), tetraethylorthosilicate (TEOS, 99%), (3-aminopropyl)triethoxysilane, 3-(methacryloyloxy)propyl]trimethoxy silane (MPS), polyethyleneglycol diacrylate (400 Da), anhydrous heptane, anhydrous toluene, anhydrous decane, trichloro(octadecyl)silane (OTS), 1H,1H,2H,2H-perfluorododecyltrichlorosilane (FTS), 1H,1H,2H,2H-perfluorododecyltriethoxysilane, Irgacure 819 and Irgacure 2959 (photoinitiators for UV curing) from Ciba, etc. ureidopropyltrialkylsilane, N-(acetylglycyl)-3-aminopropyltrimethoxysilane and trialkylpropypylmelaminesilane from Gelest Ltd, Double distilled water was obtained from a TREION™ purification system. Polyethylene (PE) films, air corona or oxygen plasma treated, were provided by Poleg, Israel. Polyethylene terephthalate (PET) films, air corona or oxygen plasma treated, were provided by Hanita coatings, Israel. Polypropylene (PP) films, air corona or oxygen plasma treated, with different roughness were provided by Mafal coatings, Israel. Polyvinyl chloride (PVC) and polycarbonate (PC) films, air corona or oxygen plasma treated, were provided by Palram, Israel.

### Characterization

Surface morphology of the films was characterized with a JEOL scanning electron microscope (SEM) model JSM-840. The sample was coated with iridium in vacuum before viewing under SEM.

FTIR measurements of the plastic films and coated films were performed by the attenuated total reflectance (ATR) technique, using Bruker ALPHA-FTIR QuickSnap™ sampling module equipped with Platinum ATR diamond module.

The sessile drop measurements (water contact angle) were done using a Goniometer, (System OCA, model OCA20, Data Physics Instruments GmbH, Filderstadt, Germany). Drops of 5 μL distilled water were dropped on five different areas of each film and images were captured a few seconds after the deposition. The static water contact angle values were performed using LaplaceYoung curve fitting. All of the measurements were done at 25° C. and 60% moisture. Each result represents an average of 5 measurements with up to 5% standard deviation. Uncoated films were used as a reference.

Preparation of Homo and Grafted SiO₂ and/or Organic-Derivatized SiO₂ Particles

Homo and grafted (bonded) silica nanoparticles (SiO₂ NPs) and/or organic-derivatized SiO₂ particles were prepared by using modified Stober polymerization procedure of tetraethylorthosilicate (TEOS) in the presence of desired plastic films. In a typical experiment, corona or plasma treated plastic (e.g., PE, PP, PET, PC and PVC) films cut into 5×8 cm² slices were inserted into a vial. Ethanol (23.5 mL), water (0.4 mL) ammonium hydroxide (1 mL) and TEOS (0.8 mL) were then added to the vial. The solution was then shaken or incubated at room temperature for12 h to form two types of silica particles: homo and grafted SiO₂. The formed silica coated films (PE/SiO₂, PP/SiO₂, PET/SiO₂, PVC/SiO₂, PC/SiO₂, etc.) were easily separated from the free particles and then washed with ethanol and then air-dried. The silica coated plastic sheets were stable, kept, more or less, the optical properties and migration was not observed.

A similar process as described in the above paragraph was accomplished substituting the monomer TEOS for 90% TEOS and 10% 3-(Methacryloyloxy)propyl]trimethoxysilane (MPS).

The double bonds derivatized silica coated plastic sheets were then used for a UV curing process

A similar process as described in the above paragraph was accomplished substituting the monomer TEOS for 90% TEOS and 10% (3-aminopropyl)triethoxysilane (APS), thereby obtaining terminal primary groups for chemical manipulations.

A similar process as described in the above paragraph was accomplished substituting the monomer TEOS for 90% TEOS and 10% ureidopropyltrimethoxysilane, thereby obtaining terminal urea groups for halogenation (e.g., chlorination) for self-cleaning applications.

A similar process as described in the above paragraph was accomplished substituting the monomer TEOS for 50% TEOS and 50% ureidopropyltrimethoxysilane, thereby obtaining terminal urea groups for halogenation (e.g., chlorination) for self-cleaning applications.

A similar process as described in the above paragraph was accomplished substituting the monomer TEOS for 90% TEOS and 10% triethoxypropylmelaminesilane, thereby obtaining terminal melamine groups for halogenation (e.g., chlorination) for self-cleaning applications.

A similar process as described in the above paragraph was accomplished substituting the monomer TEOS for 50% TEOS and 50% triethoxypropylmelaminesilane, thereby obtaining terminal melamine groups for halogenation (e.g., chlorination) for self-cleaning applications.

A similar process as described in the above paragraph was accomplished substituting the monomer TEOS for 50% TEOS and 50% N-(acetylglycyl)-3-aminopropyltrimethoxysilane, thereby obtaining terminal urea groups for halogenation (e.g., chlorination) for self-cleaning applications.

Non-derivatized and derivatized SiO₂ and/or organic-derivatized particles, grafted and non-grafted (homo), of various sizes were prepared by changing the polymerization parameters, e.g. solvent type, monomer type (Si(OR)₄ and/or Si(R′)ₙ(OR)₄₋ₙ), weight ratio of Si(OR)₄ to Si(R′)ₙ(OR)₄₋ₙ (n=1), weight ratio of the monomer to the solvent, ammonium hydroxide concentration, polymerization time, etc.

### Anti-Fog Coating

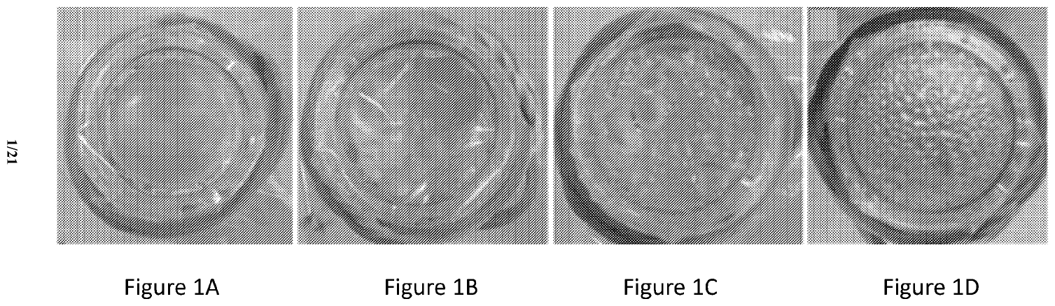

Anti-fog behavior of the films was studied using a hot fog test, conducted as follows: an open 28 mL vial filled with 10 mL water was wrapped with a 5×5 cm² film, subsequently kept in a 60° C. water bath for 180 min. Variations of the optical visibility of the films were observed and recorded at different time intervals. Ratings of A to D were used, presented in FIG. 1, where D denotes zero visibility with an opaque layer of small water droplets and A describes excellent optical performance where a transparent continuous film of water is displayed.

### Superhydrophobic Coating

In a typical experiment, 10 mg of FTS or OTS were dissolved in 20 mL anhydrous heptane (0.05% w/v) in a vial equipped with a drying tube. To this, the SiO₂ coated films (PE/SiO₂, PP/SiO₂, PET/SiO₂, PVC/SiO₂, PC/SiO₂) (3×3 cm²) were inserted. The vials were then shaken at room temperature for 5 h. The formed superhydrophobic films were then washed with heptane and ethanol and then dried in an oven for 5 min at 60° C.

Coatings of different qualities were observed by changing the coating parameters, e.g., coating time, solvent type, amphiphile types and concentrations, plastic types and roughness.

Superhydrophobic coatings on the silica grafted plastic sheets were also prepared by spraying or spreading on the silica grafted plastic films with a Mayer rod (RK Print Coat Instruments Ltd., Litlington, Royston) FTS or OTS organic solution (in solvents such as heptane or decane), followed by drying at room temperature or in an oven at 80° C. Coatings of different qualities were observed by changing the coating parameters, e.g., amphiphile types and concentrations, solvent, plastic roughness, drying temperature and time.

### Self-Cleaning Coating

In the first stage coating containing urea groups have been prepared. In a typical experiment, corona or plasma treated PP films cut into 5×8 cm² slices were inserted into a vial. Ethanol (23.5 mL), water (0.4 mL) ammonium hydroxide (1 mL) and 1-[3-(trimethoxysilyl)propyl]urea (0.8 mL) were then added to the vial. The solution was then incubated at room temperature for 12 h to form two types of urea-derivatized silica particles (SiO₂-urea): homo and grafted urea-derivatized SiO2.The formed urea-derivatized silica coated films (PE/SiO₂-urea, PP/SiO₂-urea, PET/SiO₂-urea, PVC/SiO₂-urea, PC/SiO₂-urea etc.) were easily separated from the free particles and then washed with ethanol and then air-dried. The urea-derivatized silica coated plastic sheets were durable, kept, more or less, the optical properties and migration was not observed.

A second experiment was done similarly, substituting the 0.8 mL of the urea-derivatized silane for 1.5 mL.

A similar process was accomplished in 2 steps: first layer of SiO₂ coatings as described before, followed by a second layer composed of urea-derivatized SiO₂ coatings.

Coatings of different qualities were observed by changing the coating parameters, e.g., coating time, solvent type, temperature and concentrations, plastic types and roughness.

Chloramine derivatized coatings for self-cleaning purposes were prepared by chlorination of the urea-derivatized coatings using sodium hypochlorite (NaOCl,), the active ingredient of household bleach, one of the most commonly used disinfectants in the world. Briefly, the urea-derivatized plastic films (1×1 cm² pieces)) were incubated with NaOCl aqueous solution (5 ml, 0.4% w/v) at pH 7-8 at room temperature for 1 h. Excess sodium hypochlorite was then removed from the chloramine-derivatized films coatings by extensive washing with water. The bound-Cl content of the coating films was determined by iodometric/thiosulfate titration according to the literature.

The effects of changing the chlorination process parameters, e.g., sodium hypochlorite concentration, the reaction time and temperature of the chlorination process, on the bound Cl content were determined.

A similar process was also done substituting 1-[3-(trimethoxysilyl)propyl]urea for silane compound containing amide group/s, e.g., N-(acetylglycyl)-3-aminopropyltrimethoxysilane.

### Example 2

Homo and Grafted SiO₂ Particles onto Plastic Films

Homo and grafted SiO₂ and/or organic-derivatized SiO₂ particles were prepared, as described in example 1, by polymerization of TEOS and/or Si(R′)ₙ(OR)₄₋ₙ, n=1) in an appropriate continuous phase such as ethanol or ethanol containing water, in the presence or absence (control) of surface oxidized plastic films. SiO₂ particles of two types have been formed: homo SiO₂ particles dispersed in the continuous phase and SiO₂ particles grafted onto the plastic film surface. The silica-coated films can easily be removed from the homo SiO₂ particles and then be washed and dry, as described for example in the experimental part. It should be noted that the silica coated plastic films were durable, preserved, more or less, the optical properties of the non-coated films, unless particles of sizes larger than 300 nm are bound, and migration of the bonded silica particles was not observed. On the other hand, the non-oxidized plastic films were hardly covered with SiO₂ particles after simple washing (by dipping) the films with ethanol or water.

### Characterization of Homo SiO₂ Nanoparticles

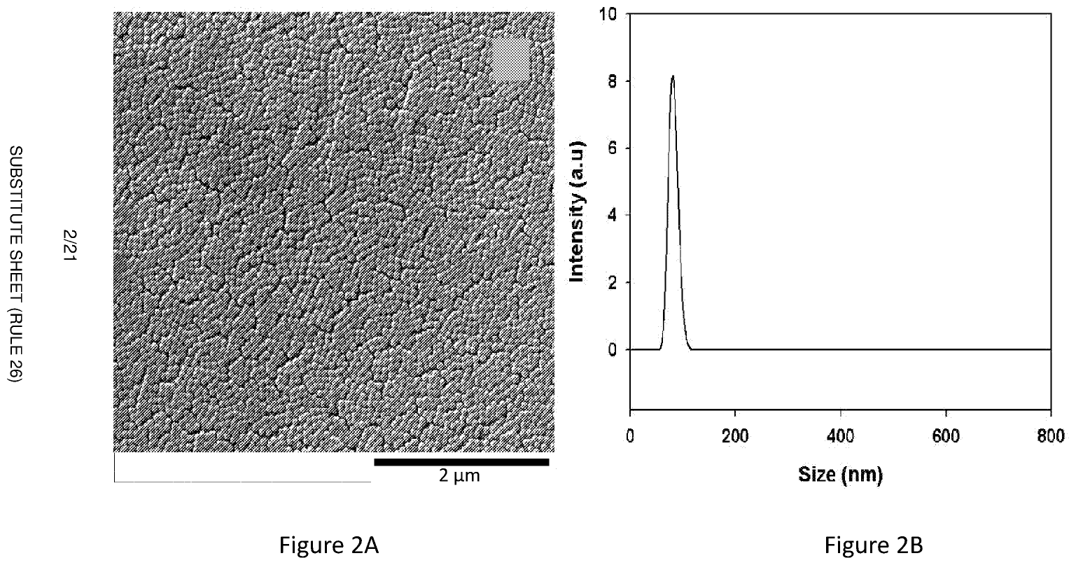

FIG. 2 presents SEM image (A) and typical hydrodynamic size histogram (B) of the homo SiO₂ NPs prepared according to the experimental section. The dry diameter and size distribution of the homo SiO₂ NPs, as shown by the SEM image, are 67±3 nm, while the hydrodynamic diameter and size distribution of the homo nanoparticles dispersed in the continuous phase, as shown by the size histogram, are 77±8 nm.

The size and size distribution of the homo SiO₂ NPs can be controlled by changing different polymerization parameters, as shown for example in Table 1, and not dependent significantly on the type of the plastic film used in the experiments. SiO₂ particles from about 10 nm up to 5 μm have been prepared by changing various polymerization parameters.

TABLE 1
Effect of polymerization parameters on the size of the homo SiO₂ NPs

| | | | | | Hydro- | |
|---|---|---|---|---|---|---|
| | | | | | dynamic | Dry |
| Exper- | Ethanol | H₂O | NH₄OH | TEOS | diameter | diameter |
| iment | (mL) | (mL) | (mL) | (mL) | (nm) | (nm) |
| 1 | 23.5 | 0.4 | 0.35 | 0.8 | 15 ± 2 | 15 ± 1 |
| 2 | 23.5 | 0.4 | 0.7 | 0.8 | 35 ± 5 | 31 ± 1 |
| 3 | 23.5 | 0.4 | 1 | 0.8 | 89 ± 12 | 67 ± 3 |
| 4 | 18.75 | 1 | 0.8 | 1.5 | 185 ± 24 | 143 ± 6 |
| 5 | 18.75 | 6.65 | 0.45 | 1.5 | 214 ± 36 | 189 ± 8 |
| 6 | 18.75 | 3 | 0.675 | 1.5 | 475 ± 62 | 355 ± 18 |

### Example 3

### Silica Particles Coated on PE Films

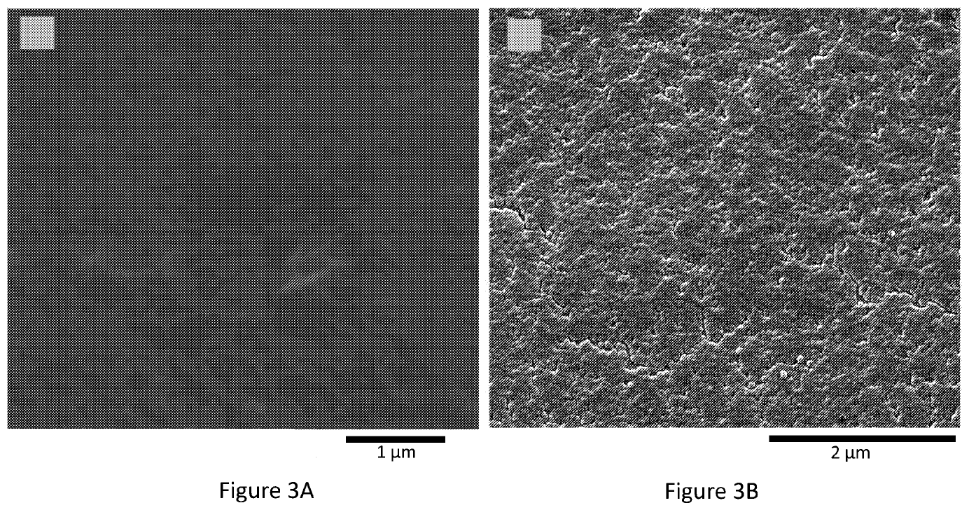

The morphology of the PE films before (A) and after (B) coating with SiO₂ NPs were characterized by SEM as shown in FIG. 3. The SEM images clearly show relatively smooth surface of the non-coated PE film compared to the rough surface of the PE/SiO₂ film. This roughness is due to the surface-attached SiO₂ NPs forming the PE/SiO₂ film. In addition, it can be observed that the SiO₂ NPs coating (48±10 nm) is homogenously distributed on the film and forms a close-packed surface. In addition, FIGS. 2 and 3 clearly illustrate that the morphology and the size of the grafted SiO₂ NPs are entirely different from that of the homo SiO₂ NPs.

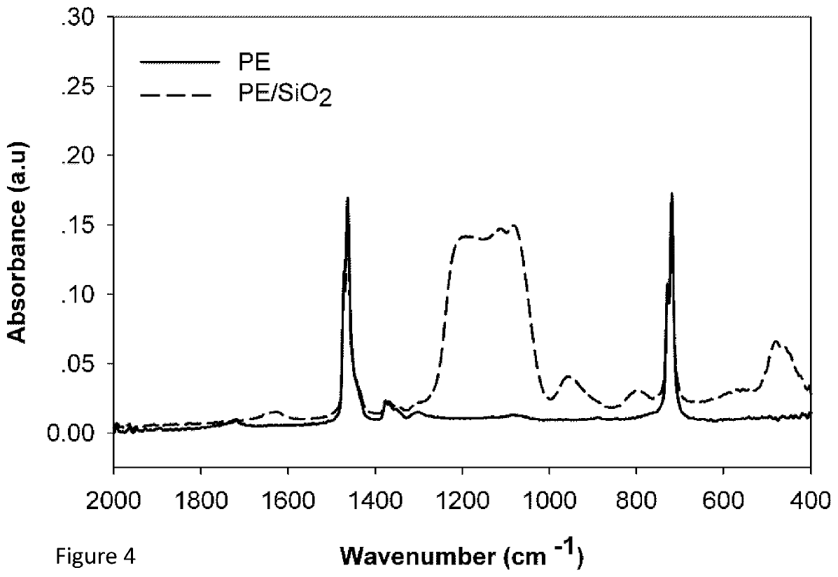

FIG. 4 illustrates the FTIR spectra of PE films before and after coating with the SiO₂NPs. The PE film spectrum (continuous line) shows typical absorbance peaks of PE at 719, 1,378 and 1,468 cm⁻¹. SiO₂ coated PE films show additional absorbance peaks of SiO₂ at 1,000-1,200, 960, 800 and 465 cm⁻¹. PE film that did not go through corona/plasma treatment, did not exhibit any SiO₂ related peaks. Thus, it can be concluded that the corona/plasma treatment is essential for the formation of grafted SiO₂ NPs.

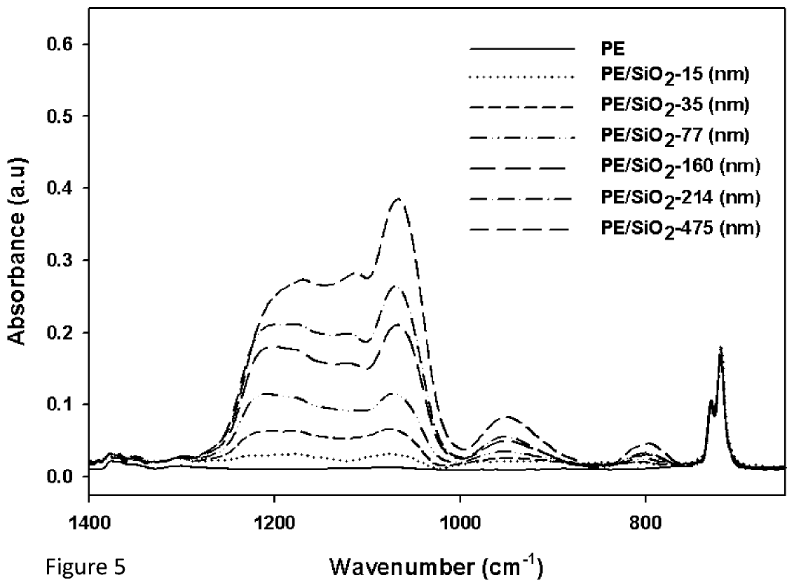

The concentration and size of the grafted SiO₂ particles can be controlled by changing polymerization parameters, e.g., coating time, ratio between water and ethanol, monomer concentration, etc. FIG. 5 illustrates the FTIR spectra of PE films coated with SiO₂ NPs of different diameters.

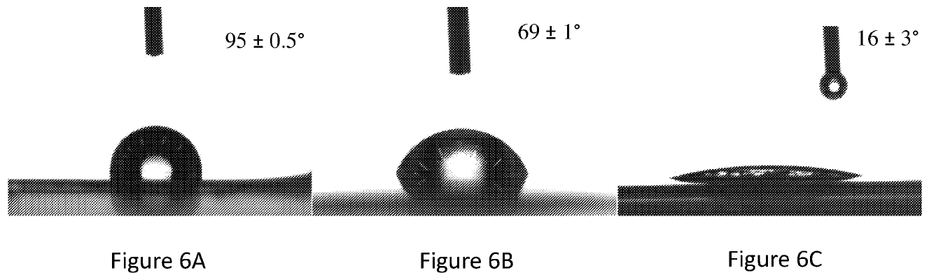

Sessile contact angle measurements of PE film (A), Corona treated PE film (B) and SiO₂ coated PE film (C) are illustrated in FIG. 6. The contact angle of PE was 95±0.5°. After corona treatment, the contact angle dropped to 69±1°. The formation of the grafted SiO₂ surface on the PE leads to a significant drop of the contact angle to 16±3°, making it more hydrophilic and suitable for anti-fogging applications.

Table 2 shows the contact angles of the PE/SiO₂ films composed of SiO₂ NPs of increasing diameter.

TABLE 2
Dry diameters of the grafted SiO₂ NPs
and contact angles of the coated PE.

| Dry diameter (nm) of the grafted SiO₂ NPs | Contact angle (°) |
|---|---|
| 16 ± 2 | 61 ± 1 |
| 30 ± 3 | 45 ± 1 |
| 48 ± 10 | 16 ± 3 |
| 82 ± 8 | 38 ± 0.5 |
| 126 ± 7 | 39 ± 4 |
| 155 ± 12 | 39 ± 5 |

### Fog Test

The anti-fogging properties of the PE/SiO₂ films were studied by the hot fog test as described in the experimental section, all the results were over 3 h of heating in 60° C. Table 3 shows the range of optical visibility through the films.

Non-coated PE film show poor visibility, ranked as D over 3 h, with no change. However, when coated by SiO₂ NPs, prepared according to Table 1 experiment 3, the visibility improves to rank A. The PE/SiO₂ films coated with SiO₂ NPs, prepared according Table 1 experiment 5 shows only rank B after 3 h.

TABLE 3
Hot fog test of PE/SiO₂ films over 3 h.

| | Test time | | | | | |
|---|---|---|---|---|---|---|
| Film type | 5 min | 10 min | 30 min | 1 h | 2 h | 3 h |
| PE | D | D | D | D | D | D |
| PE/SiO₂-214 | D | D | D | C | C-B | B |
| nm | | | | | | |
| PE/SiO₂-77 nm | D | D-C | C-B | B | A-B | A |

### Superhydrophobic PE Films

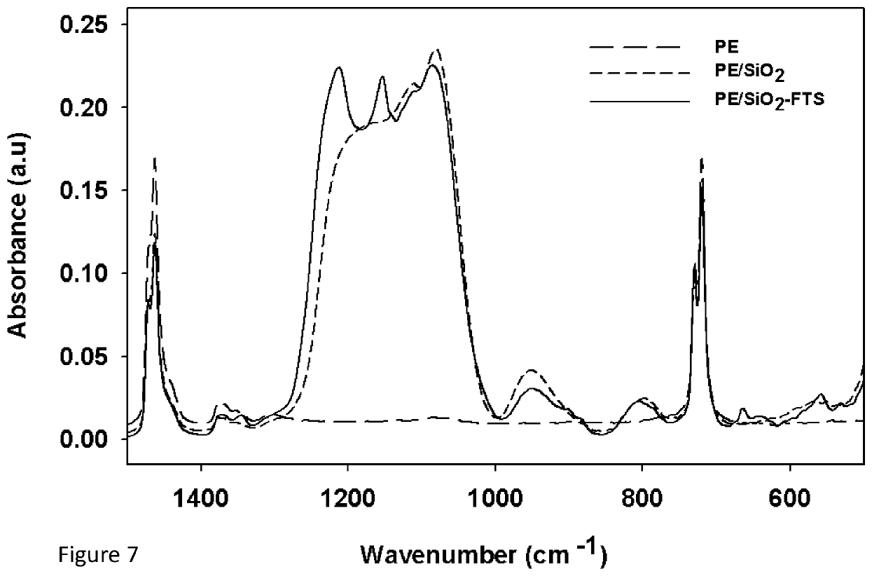

Superhydrophobic coatings were prepared by covalent binding of appropriate alkylsilane (e.g., OTS) or fluorosilane compounds (e.g., FTS) to the SiO₂ coated PE films, as described in experiment 1. FIG. 7 illustrates the FTIR spectra of PE film, PE/SiO₂ film, and PE/SiO₂FTS followed by fluorosilane treatment. Coating of PE-SiO₂ with fluorosilane leads to the presence of the absorbance peaks of C—F bond at 1,200, 1,150 and 664 cm ⁻¹, in addition to the typical SiO₂ and PE peaks.

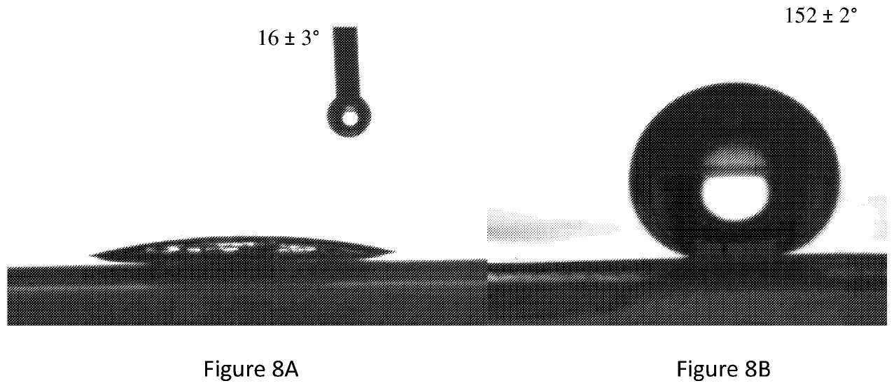

FIG. 8 shows the results of contact angle measurements of PE/SiO₂ (A) and PE/SiO₂-FTS (B). As shown above, the contact angle of PE/SiO₂ was measured to be 16±3°, while after binding to the bonded SiO₂ the FTS, the contact angle of the PE-SiO₂-FTS film was raised to be 152±2°.

### Example 4

### Silica Particles Coated on PET Films

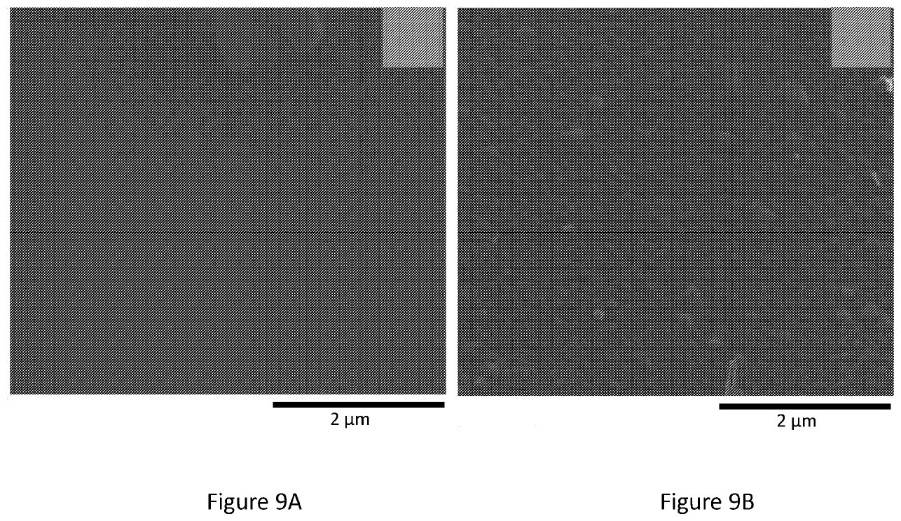

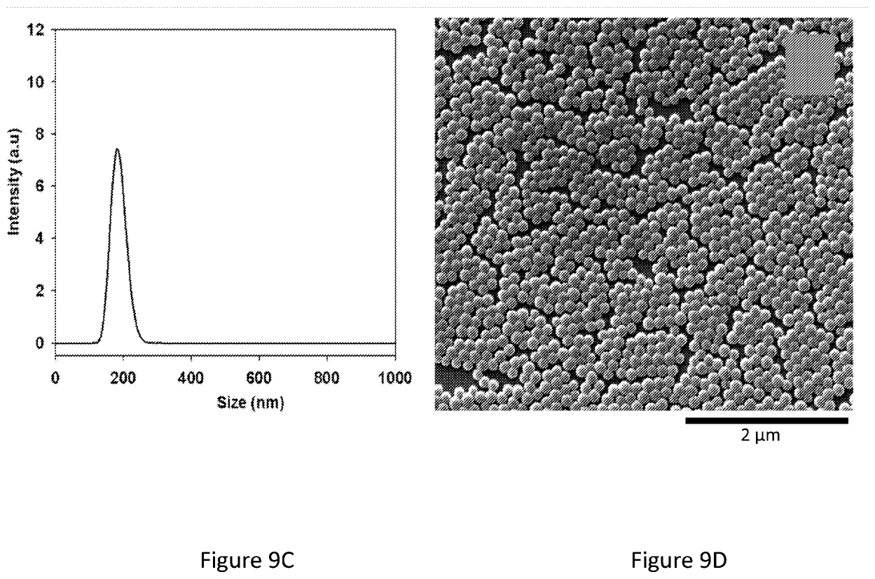

FIG. 9 shows the surface morphology of PET films before and after coating with SiO₂ NPs, and the hydrodynamic and dry diameters of the homo SiO₂ NPs formed in the polymerization continuous phase, prepared according to experimental description and Table 1, experiment 5. As shown for the PE films, the surface of the non-coated PET film is smooth compared to the rough surface of the PET-SiO₂ film. In addition, it can be observed that the homo SiO₂ NPs dry diameter is slightly higher, 189±8, than that of the close-packed grafted SiO₂ NPs, 126±7 nm.

Contact Angle

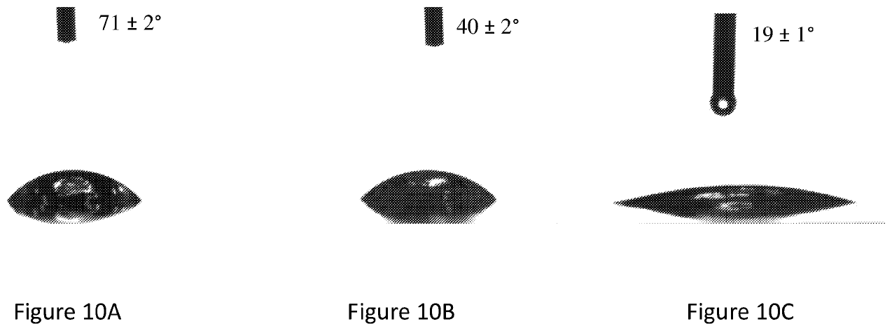

Sessile contact angle measurements of the non-treated PET film (A), PET film after plasma treatment (B), and PET/SiO₂ film (C) are illustrated in FIG. 10. The contact angle of the non-treated PET film was 71±2°. After plasma treatment, the contact angle dropped off to 40±2°. The SiO₂ coating of the PET film leads to a substantial reduction of the contact angle to 19±1°, making the PET surface much more hydrophilic than the initial PET film, and suitable for anti-fogging applications.

Table 4 shows the contact angle of the coated PET/SiO₂ films containing SiO₂ particles of different sizes and the difference in the diameter of the homo and the bonded SiO₂ NPs.

TABLE 4
Diameters of the homo and grafted SiO₂ NPs
and contact angles of the coated PET films.

| Hydrodynamic | | | |
|---|---|---|---|
| diameter of the | Dry diameter of | Dry diameter of | Contact angle of |
| homo SiO₂ | the homo SiO₂ | the grafted SiO₂ | the PET/SiO₂ |
| NPs (nm) | NPs (nm) | NPs (nm) | film (°) |
| 15 ± 1 | 15 ± 1 | 15 ± 1 | 34 ± 2 |
| 37 ± 5 | 31 ± 1 | 30 ± 5 | 39 ± 1 |
| 89 ± 12 | 75 ± 5 | 48 ± 7 | 43 ± 1 |
| 185 ± 26 | 135 ± 7 | 80 ± 5 | 43 ± 0.5 |
| 214 ± 25 | 186 ± 12 | 120 ± 9 | 19 ± 1 |
| 511 ± 62 | 364 ± 18 | 185 ± 17 | 39 ± 3 |

Table 4 illustrates, as shown for the PE films, that the dry diameter of the homo SiO₂ NPs is usually lower than that of the hydrodynamic diameter of the same sample. In addition, this table shows that the dry diameter of the grafted SiO₂ NPs is similar or lower to that of the homo SiO₂ NPs, and that difference is increased as the diameter of the homo SiO₂ NPs increasing. This table also indicates that the contact angle of the PET/SiO₂ films is dependent on the diameter of the grafted NPs, and that the lowest contact angle (19±1°) was obtained for SiO₂ grafted NPs of 126±10 nm diameter.

Table 5 summarizes the effect of the graft polymerization time of SiO₂ grafted 214±25 nm NPs on the sessile contact angle of the resulted PET/SiO₂ films. This Table indicates the decreasing in the contact angle as the polymerization time period increased.

TABLE 5
Effect of grafting time on the contact angles of the
PET/SiO₂ films prepared as described in Table 1.

| | |
|---|---|
| Coating time | Contact angle (°) |

| | | |
|---|---|---|
| 10 | min | 43 ± 2 |
| 30 | min | 46 ± 2 |
| 1 | h | 44 ± 3 |
| 2.5 | h | 23 ± 4 |
| 4.5 | h | 21 ± 2 |
| 24 | h | 19 ± 1 |

The SiO₂ grafting rate and diameter is depending on the polymerization parameters, so that it is possible to enhance or delay the grafting rate according to the demand.

### Fog Test

The anti-fogging properties of the PET/SiO₂ films were studies by the hot fog test as described in the experimental section, all the results were over 3 h of heating in 60° C. Table 6 shows the range of optical visibility through the films, ranked as A-D, as shown in FIG. 1.

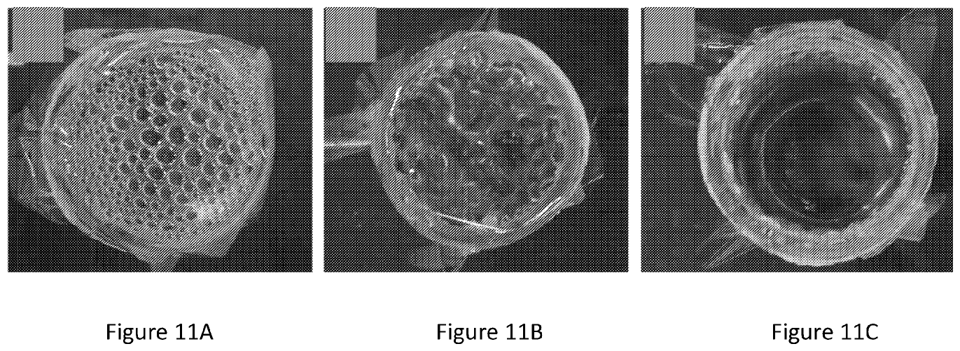

Non-coated PET films show poor visibility, ranked as D over 3 h, with no change. However, when coated by SiO₂ NPs, prepared according to the experimental part and Table 1 experiment 5, the visibility improves to rank A. The PET/SiO₂ films coated for 24 h, shows the best optical visibility, rank A, achieved within 5 min and remaining the same over 3 h in the hot fog test (FIG. 11). The PET/SiO₂ films coated with SiO₂ NPs for 4.5 h and 2.5 h shows rank A only after 30 min and 1 h, respectively.

TABLE 6
Hot fog test over 3 h.

| | Test time | | | | | |
|---|---|---|---|---|---|---|
| Film type | 5 min | 10 min | 30 min | 1 h | 2 h | 3 h |
| PET | D | D | D | D | D | D |
| Plasma treated PET | D | D | D-C | C | C | C |
| PET/SiO₂ 12 h | A | A | A | A | A | A |
| PET/SiO₂ 4.5 h | C | A-B | A | A | A | A |
| PET/SiO₂ 2.5 h | C | C-B | B-A | A | A | A |
| PET/SiO₂ | C | C | C-B | C-B | A-B | A-B |
| 10 min | | | | | | |

### Superhydrophobic PET Films

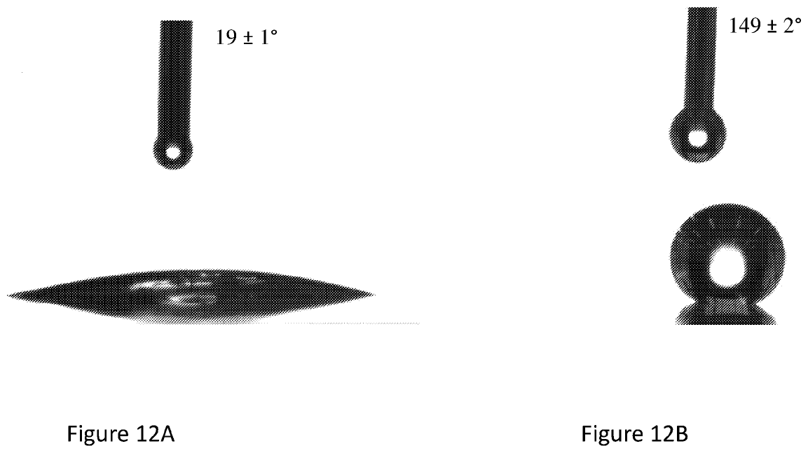

FIG. 12 shows the results of contact angle measurements of PET/SiO₂ (A) and PET/SiO₂-FTS (B) films. The contact angle of PET/SiO₂ films were measured to be 19±1° while the contact angle of PET/SiO₂-FTS films were measured to be 149±2°.

### Example 5

### Silica Particles Coated on PVC Films

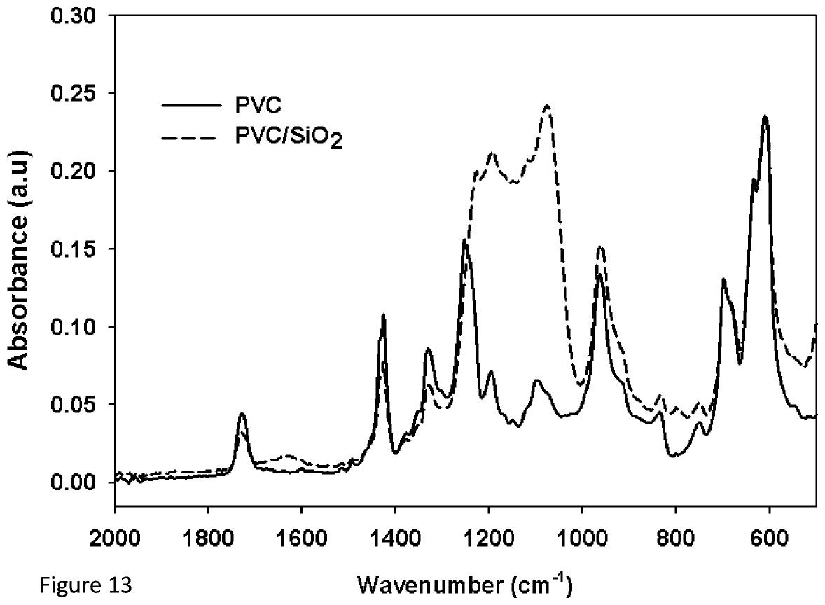

PVC/SiO₂ films were prepared as described in the experimental part. FIG. 13 illustrates the FTIR spectra of PVC films before and after grafted with SiO₂ NPs, showing the typical peaks of PVC and SiO₂ NPs.

### Fog Test

The anti-fogging properties of the PVC/SiO₂ films were studied by the hot fog test as described in the experimental section, all the results were over 3 h of heating in 60° C. Table 7 shows the range of optical visibility through the films.

TABLE 7
Hot fog test of the PVC/SiO₂ films over 3 h.

| | Hydrodynamic | | | | | | |
|---|---|---|---|---|---|---|---|
| | diameter (nm) | Test time | | | | | |
| | of the homo | 5 | 10 | 30 | | | |
| Sample | SiO₂ NPs | min | min | min | 1 h | 2 h | 3 h |
| I | 214 ± 27 | C-B | C-B | A | A | A | A |
| II | 89 ± 14 | D-C | C-B | B-A | A | A | A |
| III | 15 ± 1 | D | D | D-C | C | C-B | C-B |
| IV | Corona treated | D | D | D | D | D | D |
| | PVC | | | | | | |

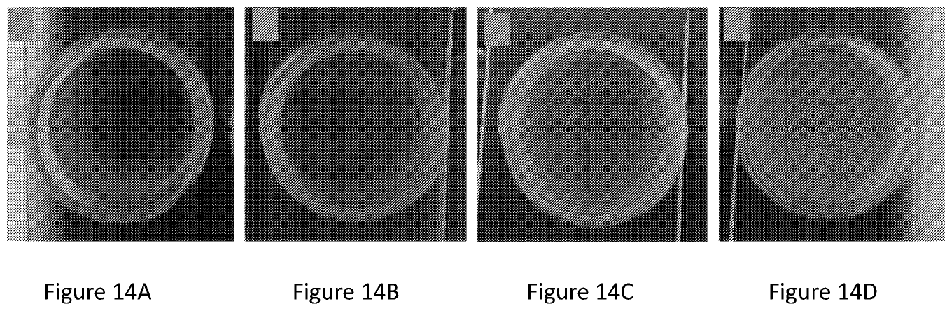

Non-coated corona treated PVC films (sample IV) show poor visibility, ranked as D over 3 h, with no change. However, when coated by SiO₂ NPs, the visibility improves to rank A, depending on the diameter of the grafted SiO₂ NPs. The PVC/SiO₂ films containing SiO₂ NPs of 214±27 nm NPs (sample I) shows the best optical visibility, rank A, achieved within 30 min and remaining the same over 3 h (FIG. 14).

### Example 6

### Effect of Roughness on the Wettability of the PP/SiO₂ Films

PP films with different roughness were coated with SiO₂ NPs as described in the experimental section, the roughness of the films ranked as A-D, when A is the smoothest and D is the roughest.

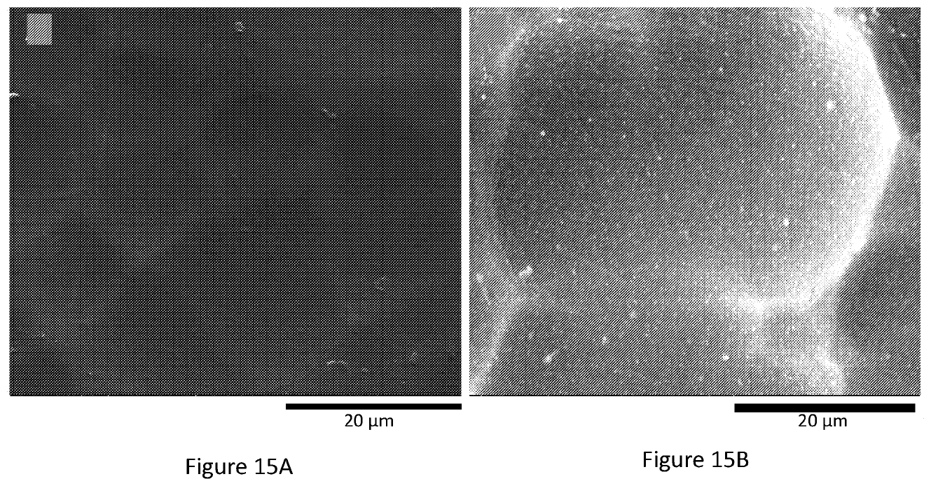

FIG. 15 shows the surface morphology of PP films ranked as C roughness, PP(C), before and after coating with SiO₂ NPs. As shown for the PE films, the images clearly illustrate the difference between the non-coated PP films and the SiO₂ coated PP films.

Table 8 illustrates the ratio between the diameter of the homo SiO₂ NPs and the contact angles of PP/SiO₂ films.

TABLE 8
Diameters of the homo SiO₂ NPs and contact
angles of the PP/SiO₂ films.

| Hydrodynamic | Dry diameter of | |
|---|---|---|
| diameter of the | the grafted SiO₂ | Contact |
| homo SiO₂ NPs (nm) | NPs (nm) | angle (°) |
| 15 ± 2 | 14 ± 1 | 79 ± 2 |
| 35 ± 5 | 32 ± 5 | 75 ± 2 |
| 96 ± 11 | 45 ± 5 | 63 ± 2 |
| 185 ± 24 | 74 ± 12 | 41 ± 3 |
| 214 ± 30 | 123 ± 11 | 37 ± 2 |
| 475 ± 54 | 178 ± 11 | 41 ± 3 |

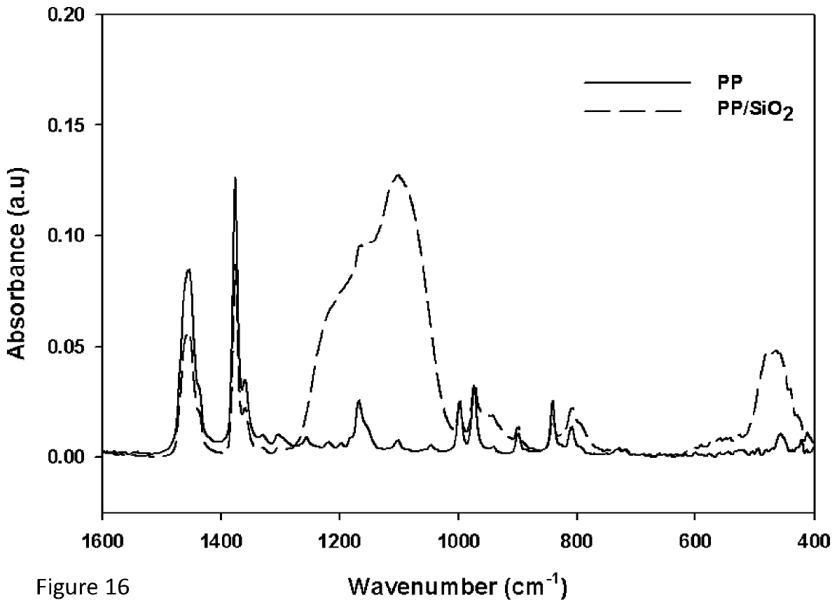

FIG. 16 illustrates the FTIR spectra of PP films before and after coating with SiO₂ NPs, showing the typical peaks of PP and SiO₂ NPs.

### Superhydrophobic PP Films

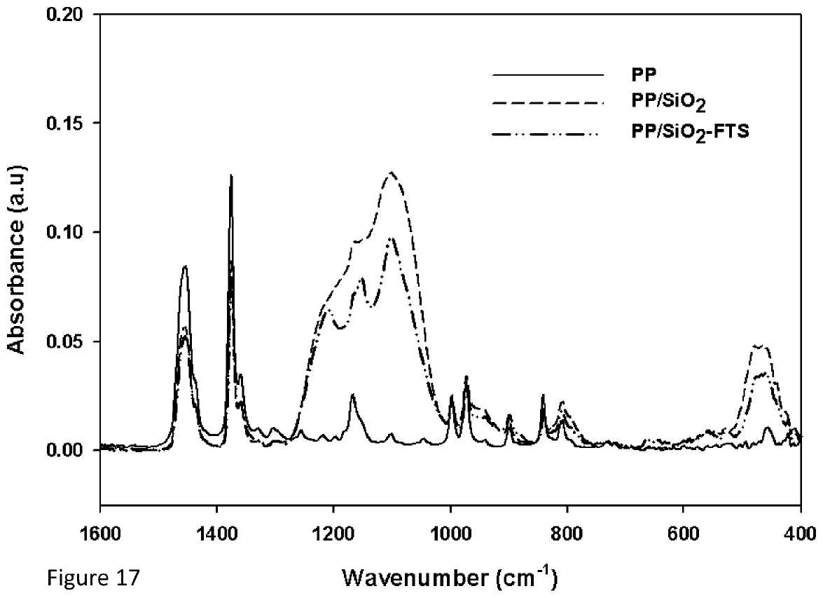

Superhydrophobic PP films of different roughness were prepared by covalent binding of appropriate alkylsilane or fluorosilane compounds (0.05% w/v) to the grafted SiO₂ NPs prepared according to Table 1. FIG. 17 illustrates the FTIR spectra of the PP, PP/SiO₂ and PP/SiO₂-FTS films.

Table 9 shows the contact angles of non-coated PP, PP/SiO₂, and PP/SiO₂-FTS films of different roughness.

TABLE 9
Contact angles of non-coated PP, and PP-
SiO₂-FTS films of different roughness

| | | | Contact | |
|---|---|---|---|---|
| | | Contact angle | angle of | Contact angle |
| PP | Roughness | of non-coated | SiO₂-coated | of PP/SiO₂- |
| roughness | Ra (μm) | PP(°) | PP(°) | FTS (°) |
| A | 0.8 | 68 ± 2 | 36 ± 1 | 138 ± 2 |
| B | 3.2 | 72 ± 3 | 35 ± 2 | 141 ± 1 |
| C | 7 | 66 ± 2 | 37 ± 2 | 151 ± 1 |
| D | 13 | 45 ± 2 | 41 ± 2 | 142 ± 3 |

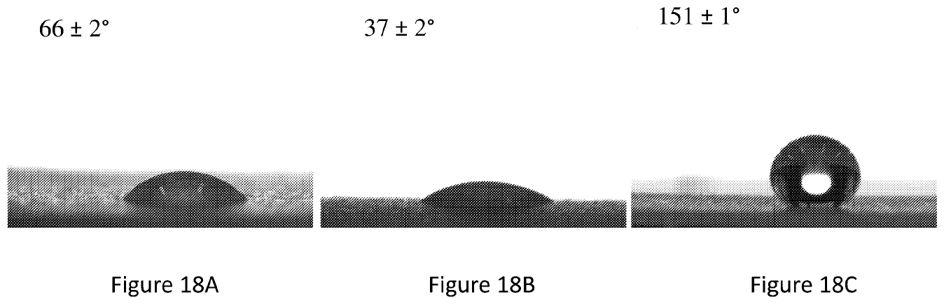

FIG. 18 shows the results of contact angle measurements of PP (A), PP(C)/SiO₂ (B) and PP(C)/SiO₂-FTS (C) films. The contact angle of corona treated PP(C) was 66±2°. After SiO₂ coating, the contact angle dropped off to 37±2° and after binding FTS to the bonded SiO₂ the measured contact angle raised to be 151±1°.

### Example 7

### Durable Anti-Fog Coatings via Preparation of Robostic-Derivatized Silica Coatings by UV Curing

A mixture of a photo-initiator (e.g., 0.5% (w/w); e.g., DW Irgacure 819 or Irgacure 2959 from Ciba) and polyethyleneglycol (PEG) diacrylate (400 Da or 800 Da) in isopropanol or ethanol was prepared (10 mg/mL). The mixture was then spread on the plastic films (PP, PE and PET) coated with the SiO₂ particles and double bonds derivatized SiO₂ particles (precursor: 3-(Methacryloyloxy)propyl]trimethoxysilane, MPS), prepared as described in experiment 1, by using Mayer rod. After the coating process, the substrates were cured under UV lamp of 365 nm, to achieve dried coated durable films (PE/SiO₂/MPS/PEG-diacrylate) suitable for part of the applications described above, e.g., anti-fogging. Properties of the plastics coated with the cured PEG diacrylate (PE/SiO₂/MPS/PEG-diacrylate) were usually superior to those without PEG diacrylate coating (PE/SiO₂/MPS).

The effect of changing polymerization parameters, e.g., photo-initiator concentration between 0.2-10%, was also studied.

### Fog Test

The anti-fogging properties of the PE/SiO₂/MPS/PEG-diacrylate films were studied by the hot fog test as described in the experimental section, all the results were over 3 h of heating in 60° C. Table 10 shows the range of optical visibility through the films.

Non-coated PE film and PE/SiO₂/MPS show poor visibility, ranked as D over 3 h, with no change. However, PE/SiO₂/MPS coated with PEG-diacrylate and followed by UV-curing, the visibility improves to rank A after 5 min.

TABLE 10
Hot fog test of PE/SiO₂/MPS/PEG-diacrylate films over 3 h.

| | Test time | | | | | |
|---|---|---|---|---|---|---|
| Film type | 5 min | 10 min | 30 min | 1 h | 2 h | 3 h |
| PE | D | D | D | D | D | D |
| PE/SiO₂/MPS | D | D | D | D | D | D |
| PE/SiO₂/MPS/PEG- | A | A | A | A | A | A |
| diacrylate | | | | | | |

Excellent anti-fog durable coatings were also obtained were the coating of the PE film with silica, via Si(OEt)₄ and with organic derivatized silica, via MPS, was done for 1-2 minutes, or when the coating process with Si(OEt)₄ was done for 1 min, followed by additional 1 min. with MPS as described in example 1. These robostic coatings were than used for preparation of excellent superhydrophobic coatings by binding fluorosilane silane (e.g., FTS) or alkylsilane compounds to these surfaces as described previously. Similar procedure with similar results were observed by substituting PE for other plastics, e.g., PP, PET, PVC, etc.

### Example 8

### Self-Cleaning Coatings (I)

In the first stage, coating containing urea groups have been prepared. In a typical experiment, corona or plasma treated PP films cut into 5×8 cm² slices were inserted into a vial. Ethanol (23.5 mL), water (0.4 mL) ammonium hydroxide (1 mL) and 1-[3-(trimethoxysilyl)propyl]urea (0.8 mL) were then added to the vial. The solution was then incubated at room temperature for 12 h to form two types of urea-derivatized silica particles: homo and grafted urea-derivatized SiO₂. The formed urea-derivatized silica coated films (PE/urea-SiO₂, PP/urea-SiO₂, PET/urea-SiO₂, PVC/urea-SiO₂, PC/urea-SiO₂ etc.) were easily separated from the free particles and then washed with ethanol and then air-dried. The urea-derivatized silica coated plastic sheets were durable, kept, more or less, the optical properties and migration was not observed.

A second experiment was done similarly, substituting the 0.8 mL of the urea-derivatized silane for 1.5 mL.

A similar process was accomplished in 2 steps: first layer of SiO₂ coatings as described before, followed by a second layer composed of urea-derivatized SiO₂ coatings.

Coatings of different qualities were observed by changing the coating parameters, e.g., coating time, solvent type, temperature and concentrations, plastic types, e.g., PVC, PC, etc., and roughness, etc.

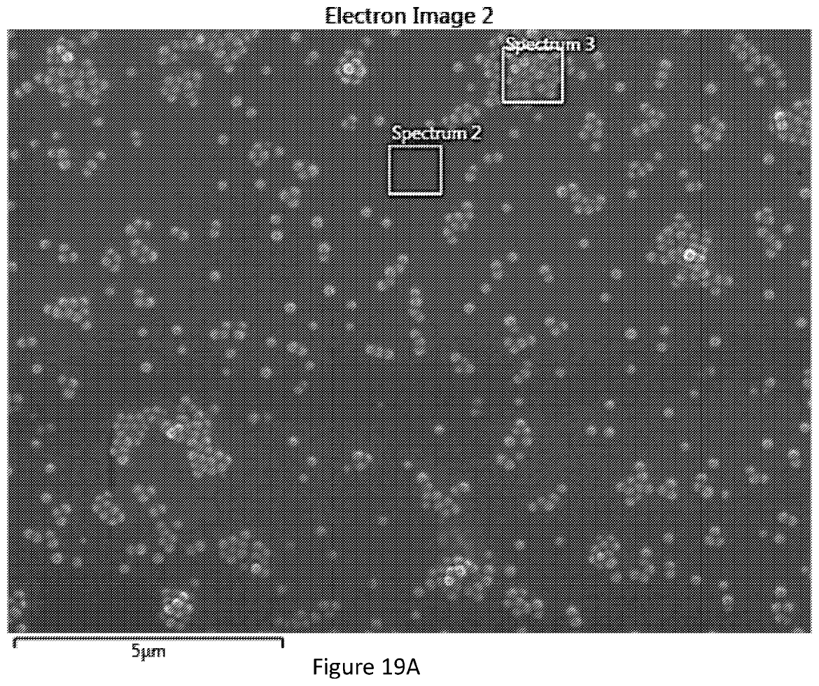

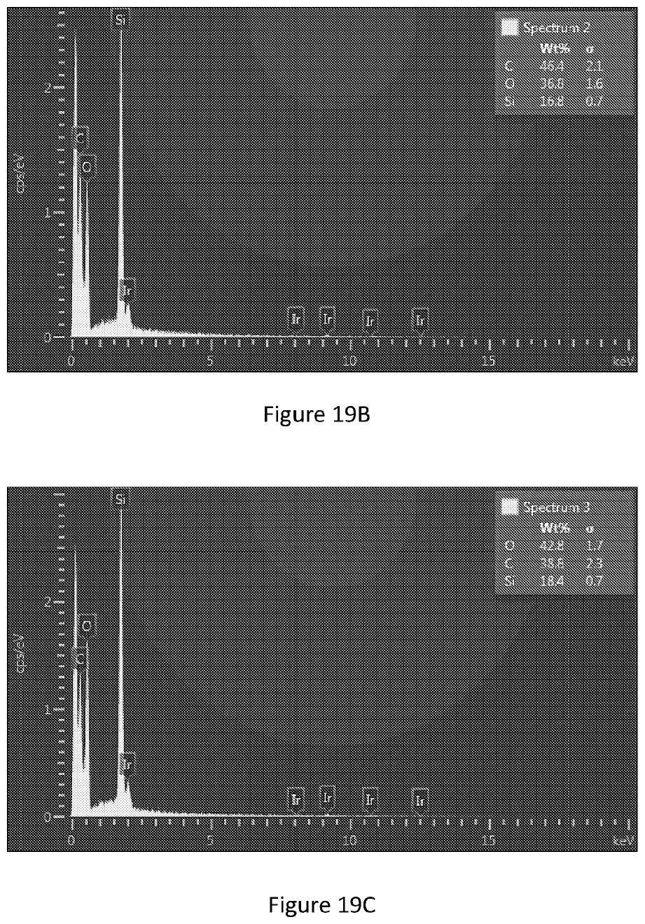

Chloroamine derivatized coatings for self-cleaning purposes were prepared by chlorination of the urea-derivatized coatings using sodium hypochlorite (NaOCl,), the active ingredient of household bleach, one of the most commonly used disinfectants in the world. Briefly, the urea-derivatized plastic films (1×1 cm² pieces)) were incubated with NaOCl aqueous solution (5 ml, 0.4% w/v) at pH 7-8 at room temperature for 1 h. Excess sodium hypochlorite was then removed from the chloramine-derivatized films coatings by extensive washing with water. FIG. 19A illustrates by SEM the urea derivatized coating obtained according to the first typical process described in the present example. ATR experiments clearly illustrated the amide bonds of the coating. SEM coupled with EDAX experiments (FIG. 19B-19C) indicate that the coating is composed of 2 sub-layers, the first layer is tightly contact to the film surface while the second sub-layer is above the first one and composed of larger size urea-derivatized particles.

Bound-Cl content of the coating films was determined by iodometric/thiosulfate titration according to the literature. In the first coating process the bound Cl concentration was 0.8 mM/cm² while in the second coating process, wherein the concentration of the urea-derivatized silane was higher, 2.0 mM/cm², 3 additional dechlorination/chlorination cycles were done at room temperature with the PP/SiO₂-urea films, obtaining similar activated bound Cl concentration.

The effects of changing the chlorination process parameters, e.g., sodium hypochlorite concentration, the reaction time and temperature of the chlorination process, on the bound Cl content were determined. Both parameters leads to increase in the bound activated Cl concentration.

These chloreamine films inactivated (7 logs) both Staphyllococcus aureus and Escherichia coli. In addition, in the field (incubation with treated wastewater) they showed excellent antifouling activity compared with the control (unchlorinated films). The decomposition of methyl red dye by the activated chlorine was also demonstrated.

### Example 9

### Self-Cleaning Coatings via UV Curing (II)

Additional self-cleaning coatings were prepared via the following steps:

Coating containing activated double bond groups have been prepared by coating poly[3-(Methacryloyloxy)propyl]trimethoxysilane] onto plastic sheets. In a typical experiment, corona or plasma treated PP films cut into 5×8 cm2 slices were inserted into a vial. Ethanol (23.5 mL), water (0.4 mL) ammonium hydroxide (1 mL) and 3-(Methacryloyloxy)propyl]trimethoxysilane (0.8 mL) were then added to the vial. The solution was then incubated at room temperature for 6 h to form two types of activated double bond-derivatized silica particles: homo and grafted activated double bond-derivatized SiO₂. The formed activated double bonds-derivatized silica coated films PP/activated double bonds-SiO₂ were easily separated from the free particles and then washed with ethanol and then air-dried.

A mixture of a water soluble photo-initiator (e.g., 0.4% (w/w); e.g., N-phenyl glycine (Sigma)) and crosslinked polyamide nanoparticles dispersed in water prepared (20 mg/mL) was prepared. The mixture was then spread on the plastic PP sheets grafted with the activated double bond-derivatized SiO₂, prepared as described above, by using Mayer rod. After the coating process, the substrates were cured under UV lamp of 365 nm, to achieve dried coated durable films (PP/activated double bonds SiO₂/polyamide nanoparticles) suitable for chlorination with bleach as described in example 8. Briefly, the PP/activated double bonds SiO₂/polyamide nanoparticles) plastic films (1×1 cm² pieces)) were incubated with NaOCl aqueous solution (5 ml, 0.4% w/v) at pH 7-8 at room temperature for 1 h. Excess sodium hypochlorite was then removed from the chloramine-derivatized films coatings by extensive washing with water.

The formed chloreamine films inactivated both Staphyllococcus aureus and Escherichia coli, and in the field (incubation with treated wastewater) they showed excellent antifouling activity compared with the control (unchlorinated films).

### Example 10

### Scratch Resistant Coatings

PP/SiO₂-500nm, PP/SiO₂-70 nm, PP/SiO₂-30 nm and PP/SiO₂-15 nm sheets were tested under the following conditions:

Temperature exposer: −54° C./+71° C., 5 cycles of 2 h at each temperature;

Humidity: 95% RH/49° C., 24 hours;

Severe abrasion: 20 strokes at 2 lb pressure with an eraser.

The PP/SiO₂ 15, 30 and 70 nm -treated samples hardly were affected by the conditions made above as could be seen by naked eyes and by microscopy. On the other hand, the coating belonging to the PP/SiO₂-500 nm was partially removed and scratches were observed on the surface.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

1. A process for coating a substrate with a plurality of oxide particles, comprising the steps of (i) providing a substrate selected from an hydrophilic substrate, or an at least partially oxidized substrate; and (ii) contacting one or more oxide monomers with said substrate, under conditions suitable for said one or more oxide monomers to polymerize into oxide particles bound to said substrate, thereby forming a first layer of a plurality of oxide particles coating a substrate.

2. The process of claim 1, further comprising a step (iii) of washing the substrate to remove non-bound oxide particles.

3. The process of claim 1, further comprising a step (iv) of contacting one or more oxide monomers with said substrate under conditions suitable for said one or more oxide monomers to polymerize into oxide particles bound to said first layer, thereby forming a second layer.

4. The process of claim 1, wherein said contacting is via dipping, spraying, spreading, curing, or printing.

5. The process of claim 1, wherein said one or more oxide monomers are selected from having a general formula of M(OR)₄, M(R′)ₙ(OR)₄₋ₙ, or a combination thereof, wherein M is a metal selected from Si, Ti, Zn, or Fe, and R and R′ are each independently selected from hydrogen, methyl, alkyl, alkenyl, alkynyl, cycloalkyl, heteroalicyclic, aryl, heteroaryl, hydroxy, alkoxy, aryloxy, thiohydroxy, thioalkoxy, thioaryloxy, halide, amine, amide, carbonyl, thiocarbonyl, carboxy, thiocarboxy, epoxide, sulfonate, sulfonyl, sulfinyl, sulfonamide, nitro, nitrile, melamine, isonitrile, thiirane, aziridine, nitroso, hydrazine, sulfate, azide, phosphonyl, phosphinyl, urea, thiourea, carbamyl and thiocarbamyl; and wherein the one or more oxide monomers are in a solution comprising a protic solvent, selected from the group consisting of: water, ethanol, methyl ethyl ketone, isopropanol, methanol, butanol and a combination thereof.

6. The process of claim 1, wherein said substrate comprises a polymeric substrate, or a glass substrate.

7. The process of claim 6, wherein said glass substrate is selected from a borosilicate-based glass substrate, silicon-based glass substrate, ceramic-based glass substrate, silica/quartz-based glass substrate, aluminosilicate-based glass substrate, or any combination thereof; and (ii) said polymeric substrate polycarbonate (PC), high-density polyethylene (HDPE), low-density polyethylene (LDPE), very low-density polyethylene (VLDPE), polyester, polyethylene terephthalate (PET) polycarbonate (PC), polyvinyl chloride (PVC), polymethyl methacrylate (PMMA), silicon, polyacetal, silicone rubber, cellulose, cellulose derivatives, poly(2-hydroxyethyl methacrylate) (pHEMA), nylon, and any combination thereof.

8. (canceled)

9. (canceled)

10. The process of claim 5, wherein said solution is devoid of a curing agent, a film former, a surfactant, or a stabilizer.

11. The process of claim 5, wherein said solution further comprises a silane coupling agent.

12. The process of claim 11, wherein said silane coupling agent is selected from the group consisting of: 3-(Methacryloyloxy)propyl]trimethoxysilane (MPS), 3-(aminooxy)propyl]trimethoxysilane (APS), uridopropyltrimethoxysilane, trialkylpropypylmelaminesilane, triethoxysilylpropyl hydantoin and any combination thereof.

13. The process of claim 11, wherein the ratio of said oxide precursor and said coupling agent ranges from 95:5 to 5:95, respectively.

14. The process of claim 1, for receiving any one of: (i) a composition characterized by a water contact angle of at least 130°; (ii) a scratch resistant composition; and (iii) an anti-fouling composition.

15. (canceled)

16. (canceled)

17. A composition comprising a substrate and a plurality of oxide particles, wherein: (i) said plurality of said particles are cross-linked between them and linked to a portion of at least one surface of said substrate; (ii) said plurality of said particles have a median size of 3 nm to 500 nm; and (iii) said plurality of said particles are in the form of a first layer having a thickness of 0.001 μm to 5.0 μm.

18. The composition of claim 17, wherein said plurality of said particles are selected from: (i) particles having a median size of about 5 nm to about 150 nm; and (ii) particles formed in-situ in contact with said substrate.

19. The composition of claim 17, wherein said first layer has a thickness of 1 nm to 450 nm.

20. The composition of claim 17, further comprising a second layer comprising oxide particles cross-linked between them and linked to said first layer and (iv) one or more hydrophobic agents covalently linked to said oxide particles of said second layer, wherein said composition is characterized by a water contact angle of at least 130°.

21. The composition claim 17, wherein said cross-link is selected from (i) a hydrogen bond, covalent bond, or both; and (ii) a link not obtained using a curing agent.

22. (canceled)

23. (canceled)

24. The composition of claim 17, wherein said substrate comprises a polymeric substrate, or a glass substrate.

25. (canceled)

26. (canceled)

27. The composition of claim 17, wherein said oxide particles are selected from the group consisting of: TiO₂, ZnO, FeO, Fe₂O₃, SiO₂, SiO₂—R, and any combination thereof, wherein R is (CH₂)ₙX, n=1 to 30, and X is a functional group selected from activated double bond, amine, urea, thiourea, melamine, hydantoin, thiol, carboxylate, azide, nitroso, carbonyl, and carboxy.

28. The composition of claim 17, further comprising a second layer, optionally said second layer comprises any one of: (i) SiO₂—R, wherein R is (CH₂)ₙX, n=1 to 30, and X is a functional group selected from activated double bond, amine, urea, thiourea, melamine, hydantoin, thiol, carboxylate, azide, nitroso, carbonyl, and carboxy; and (ii) one or more hydrophobic agents covalently linked to the particles, optionally wherein the one or more hydrophobic agents comprise an alkylsilane, a fluorolsilane, uridoalkylsilane, or a combination thereof; optionally wherein the composition is characterized by a water contact angle on the surface of said second layer of at least 130°.

29.-41. (canceled)
